(19) United States
(12) Patent Application Publication
(10) Pub. No.: US 2026/0141114 A1
(43) Pub. Date: May 21, 2026

(54) Automatic De-Identification of Sensitive Data with De-Identification Evaluation

(71) Applicant: Oracle International Corporation, Redwood Shores, CA (US)

(72) Inventors: Praphul Singh, Pleasanton, CA (US); Charlotte Alizerine Dzialo, Oakland, CA (US); Brad Warren Jacobs, Edmonds, WA (US)

(73) Assignee: Oracle International Corporation, Redwood Shores, CA (US)

(21) Appl. No.: 18/952,542

(22) Filed: Nov. 19, 2024

(51) Int. Cl. G06F 21/62

(52) U.S. Cl. CPC G06F 21/6254

(57) ABSTRACT

A method and system for enhancing sensitive entity de-identification in textual data using large language models (LLMs) are disclosed. The method includes performing a primary de-identification procedure on input text to identify an initial set of sensitive entities, constructing a prompt containing the identified entities and a portion of the input text, and processing the prompt using an LLM to identify additional sensitive entities not detected in the primary procedure. A de-identified text is generated by removing both the initially identified entities and the LLM-identified entities from the input text. The de-identified text is stored in a non-transitory computer-readable medium. The system improves recall in sensitive information detection by leveraging LLMs'advanced language understanding capabilities to complement traditional de-identification methods, resulting in more comprehensive protection of sensitive information in applications such as medical records processing.

### TECHNICAL FIELD

This disclosure relates generally to computer-implemented data processing. More particularly, this disclosure relates to computer-implemented de-identification of sensitive data with de-identification evaluation.

### BACKGROUND

Computer-implemented de-identification of sensitive data involves removing or obscuring personally identifiable information and other sensitive information from electronic data records. This process aims to protect privacy while allowing data to be used for research or analysis.

Manual de-identification of sensitive data involves human reviewers meticulously examining and redacting personally identifiable information from individual electronic data records. This process requires substantial time investment, as a document may need to be scrutinized for potential identifiers. Due to the labor-intensive nature of the task requiring skilled personnel with knowledge of privacy regulations and domain terminology, costs escalate rapidly. Scalability becomes a significant challenge when confronted with large datasets. As volume increases, the time and resources required grow linearly, if not exponentially.

Human reviewers are susceptible to fatigue and errors, particularly when dealing with extensive electronic data records. Consistence in applying de-identification rules across a large corpus proves difficult to maintain. Furthermore, manual processes struggle to keep pace with the ever-increasing generation of electronic data records and other sensitive data sources. The inherent limitations of human processing speed create bottlenecks in data flow, impeding timely analysis and research.

While manual review may be suitable for small, sensitive datasets, the approach quickly becomes impractical for big data applications in healthcare and medical research, financial services, education, and government and public administration. Automated or semi-automated de-identification tools offer more viable solutions for handling large-scale sensitive data de-identification tasks though these methods present their own challenges in terms of accuracy and adaptability to diverse data formats.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

One or more embodiments of the present disclosure are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a computer-implemented technique for enhancing sensitive entity de-identification using a large language model in accordance with one or more embodiments;

FIG. 2 illustrates sensitive entity type verification through LLM prompting in accordance with one or more embodiments;

FIG. 3 illustrates entity verification and selective text generation in accordance with one or more embodiments;

FIG. 4A illustrates dual-pass entity validation with secondary LLM review where an entity is incorrectly identified as sensitive in accordance with one or more embodiments;

FIG. 4B illustrates dual-pass entity validation with secondary LLM review where a sensitive entity is confirmed as sensitive in accordance with one or more embodiments;

FIG. 5 illustrates entity type reclassification using multiple LLM analysis in accordance with one or more embodiments;

FIG. 6 illustrates precision measurement and alert generation in accordance with one or more embodiments;

FIG. 7 illustrates recall value assessment and alert system in accordance with one or more embodiments;

FIG. 8 illustrates a method for automatic de-identification of sensitive data with de-identification evaluation in accordance with one or more embodiments;

FIG. 9 illustrates an example transformer architecture that may be used in the implementation of an LLM in accordance with one or more embodiments; and

FIG. 10 illustrates an example computer system for use in implementing computer-implemented de-identification of sensitive data with de-identification evaluation in accordance with one or more embodiments.

### DETAILED DESCRIPTION

In the following detailed description, for the purposes of explanation, numerous specific details are set forth to aid understanding of one or more embodiments of the present disclosure. In some instances, an embodiment of the present disclosure may be practiced without one or more of these specific details. In some cases, a described feature of one embodiment of the present disclosure is also a feature of one or more other embodiments of the present disclosure even though the feature is not expressly described with respect to one or more other embodiments. In some embodiments, well-known structures and devices are shown in the figures in block diagram form to avoid unnecessarily obscuring the embodiment.
1. GENERAL OVERVIEW
2. ENHANCING SENSITIVE ENTITY DE-IDENTIFICATION USING AN LLM
3. ENTITY TYPE VERIFICATION THROUGH LLM PROMPTING
4. ENTITY VERIFICATION AND SELECTIVE TEXT GENERATION
5. DUAL-PASS ENTITY VALIDATION WITH SECONDARY LLM REVIEW
6. ENTITY TYPE RECLASSIFICATION USING MULTIPLE LLM ANALYSIS
7. PRECISION MEASUREMENT AND ALERT GENERATION
8. RECALL VALUE ASSESSMENT AND ALERT SYSTEM
9. METHOD FOR AUTOMATIC DE-IDENTIFICATION OF SENSITIVE DATA WITH DE-IDENTIFICATION EVALUATION
10. EXAMPLE EMBODIMENT
11. PRACTICAL APPLICATIONS; ADVANTAGES; IMPROVEMENTS
12. EXAMPLE LLM ARCHITECTURE
13. COMPUTER NETWORKS AND CLOUD NETWORKS
14. HARDWARE OVERVIEW
15. MISCELLANEOUS; EXTENSIONS

### 1. General Overview

One or more embodiments enhance the recall of sensitive entity de-identification in textual data by integrating large language models (LLMs) into the de-identification process. An input text undergoes a primary de-identification procedure that identifies a set of sensitive entities. A prompt that includes this set of entities and at least a portion of the input text is constructed and sent to an LLM. The LLM processes this prompt and outputs an additional entity that was not identified by the initial de-identification process. Based on the LLM's output, a de-identified text is generated by removing both the entities from the initial set and the newly identified entity from the relevant portion of the input text. This de-identified text is then stored in a non-transitory, computer-readable medium. By utilizing the advanced language understanding capabilities of LLMs to detect sensitive entities that may have been missed initially, one or more embodiments improve recall, leading to a more comprehensive and effective de-identification of sensitive information in the input text.

One or more embodiments solve the technical problem of incomplete de-identification of sensitive entities in textual data. De-identification processes may utilize rules or algorithms that miss sensitive entities due to the nuances and complexities of natural language. This results in insufficient recall posing significant risks to privacy and regulatory compliance. The challenge is particularly acute in large and diverse datasets, such as medical records, where the variability of expressions and terminology makes exhaustive manual identification impractical and error prone. By incorporating an LLM to analyze the text and identify additional sensitive entities that were not detected by the initial de-identification process, one or more embodiments enhance the recall rate. This automated approach addresses the limitations of prior methods by leveraging the advanced language understanding capabilities of LLMs, ensuring a more comprehensive and effective de-identification of sensitive information in the input text.

One or more embodiments described in this Specification and/or recited in the claims may not be included in the General Overview section.

### 2. Enhancing Sensitive Entity De-Identification Using an LLM

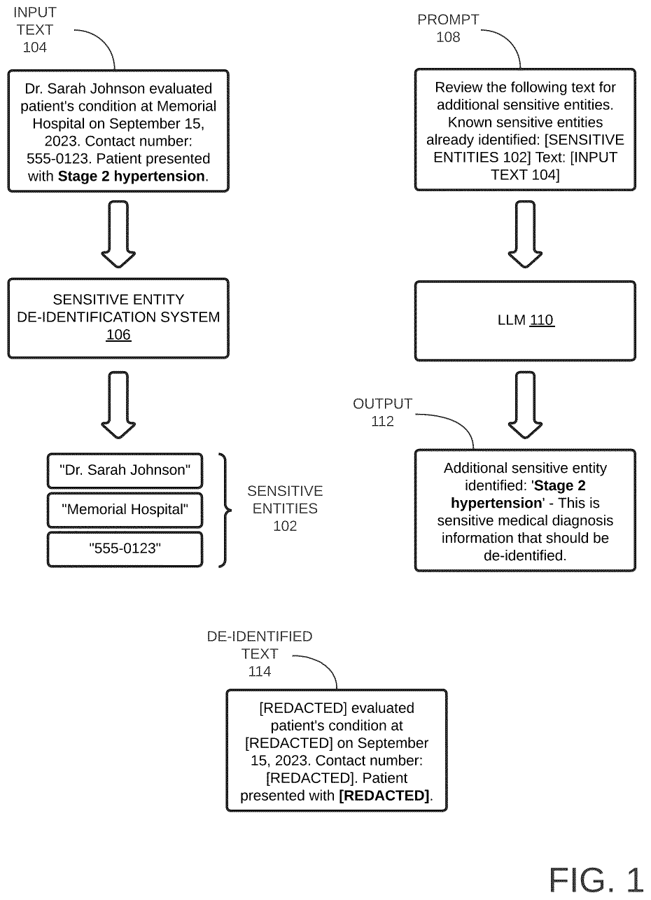

FIG. 1 illustrates a computer-implemented technique for enhancing sensitive entity de-identification using a LLM in accordance with one or more embodiments. A sensitive entity de-identification system 106 processes an input text 104 to identify a set of entities 102 as sensitive entities. The technique constructs a prompt 108 that incorporates both the identified set of entities and at least a portion of the input text. The prompt 108 is then transmitted to an LLM 110 for analysis. The LLM 110 generates an output 112 that identifies an additional entity as sensitive, where this entity was not previously included in the set of entities identified by the sensitive entity de-identification system 106. Based on the LLM's output 112 indicating the additional entity as sensitive, the technique generates a de-identified text 114. This de-identified text 114 includes at least a portion of the input text 104 while excluding both the originally identified set of entities and the newly identified sensitive entity. The technique concludes by storing the de-identified text 114 in a non-transitory, computer-readable medium for persistent storage.

The input text 104 comprises a sequence of natural language text that includes one or more sensitive entities requiring de-identification. These sensitive entities may include personal identifiers, contextual information, dates, numerical values, or other forms of protected data embedded within the text. The input text 104 represents raw, unprocessed content that may not yet have undergone any de-identification procedures. Such text 104 may originate from various sources and domains where privacy preservation is useful. The input text 104 serves as the primary data source for the subsequent de-identification process, containing both sensitive and non-sensitive information that requires appropriate identification and handling.

As used herein, a “sensitive entity” represents a discrete unit of information within text that requires protection due to privacy, security, or regulatory considerations. Such an entity may constitute personal identifiers, protected attributes, confidential information, or domain-specific data elements that could enable identification or reveal protected characteristics. Sensitive entities can appear in various forms, including names, numeric sequences, dates, locations, or contextual information that becomes sensitive through association with other elements. These entities may require special handling, such as removal, replacement, or transformation, to maintain confidentiality while preserving the utility of the surrounding text. The classification of an entity as sensitive may depend on multiple factors, including applicable regulations, organizational policies, domain context, and the potential risk of re-identification or unauthorized disclosure.

In the example of FIG. 1, the input text 104 comprises a medical record excerpt containing multiple categories of sensitive information that requires de-identification. This input text 104 includes personal identifiers, such as a healthcare provider name (“Dr. Sarah Johnson”), a healthcare facility name (“Memorial Hospital”), a specific date (“Sep. 15, 2023”), and a contact phone number (“555-0123”). The input text 104 further includes clinical information describing a medical condition (“Stage 2 hypertension”). Such an input text 104 represents a typical use case where comprehensive de-identification is useful for protecting patient privacy while maintaining the utility of the medical documentation for authorized purposes. The presence of diverse sensitive entities within this relatively short text segment demonstrates the complexity of the de-identification task and the importance of high recall in identifying sensitive information.

The sensitive entity de-identification system 106 comprises a computational system configured to process the input text 104 and identify sensitive entities requiring removal or replacement. This system 106 employs one or more de-identification techniques that may include, for example, rule-based pattern matching, statistical models, and/or machine learning algorithms. The sensitive entity de-identification system 106 performs the primary identification of sensitive entities by analyzing textual patterns, contextual cues, and predefined categories of protected information. The system 106 generates structured output containing the set of identified sensitive entities while maintaining references to their locations within the input text 104. Such a system 106 represents the initial layer of sensitive entity detection though the system 106 may not identify all sensitive entities due to the complexities of natural language and variations in expressing sensitive information.

The set of entities 102 comprises a collection of sensitive entities initially identified by the sensitive entity de-identification system from the input text 104. These entities represent distinct pieces of information that have been flagged for removal or modification during the de-identification process. An entity in the set may be associated with metadata, such as entity type, location within the input text 104, and/or contextual attributes. The set of entities serves as a baseline identification of sensitive information though this set may be incomplete due to limitations in the primary detection methods. Such entities could encompass various categories of sensitive information, including but not limited to personal identifiers, protected attributes, or domain-specific confidential data. The set maintains structural relationships between identified entities while providing a foundation for further enhancement through additional processing steps.

In the example of FIG. 1, the set of entities 102 comprises three distinct sensitive entities identified by the sensitive entity de-identification system 106 from the input text 104. The first entity, “Dr. Sarah Johnson”, represents a healthcare provider's name, including both title and full name components. The second entity, “Memorial Hospital”, represents a healthcare facility name. The third entity, “555-0123”, represents a contact phone number in a standardized format. These entities constitute structured sensitive information that has been successfully identified during the primary de-identification phase. An entity in the set maintains a specific relationship to protected health information (PHI) categories, requiring removal or modification for compliance with privacy regulations. The set forms an initial collection of identified sensitive information though additional sensitive entities may exist in the input text 104 that were not captured in this primary identification.

The prompt 108 comprises a structured input designed for transmission to the LLM, containing two primary components. The first component includes the set of entities previously identified as sensitive by the sensitive entity de-identification system 106. The second component includes at least a portion of the input text 104, providing necessary context for additional sensitive entity identification. The prompt 108 represents a formatted query that enables the LLM 110 to analyze both the known sensitive entities and the contextual information in conjunction. This structured format facilitates the LLM 110's ability to identify additional sensitive entities that may have been missed during the primary de-identification phase. The prompt 108 serves as a bridge between the initial de-identification results and the advanced language understanding capabilities of the LLM 110.

As used herein, a “prompt” represents a formatted input sequence specifically constructed to elicit a targeted response from an LLM. The prompt typically combines instructions, context, and relevant data in a structure that guides the LLM's analysis and output generation. Such formatting may include natural language instructions, examples, constraints, or specific patterns that define the expected processing behavior. The prompt serves as a communication interface between the system and the LLM, encoding task requirements and relevant information in a manner that leverages the LLM's language understanding capabilities. Design choices in prompt construction directly influence the quality and relevance of the LLM's output, making prompt engineering useful for achieving desired results.

In the example of FIG. 1, the prompt 108 comprises a structured query that begins with a specific instruction: “Review the following text for additional sensitive entities.” This instruction is followed by two distinct data fields. The first field, labeled “Known sensitive entities already identified:”, includes the set of entities 102 previously identified by the sensitive entity de-identification system 106. The second field, labeled “Text:”, includes at least a portion of the input text 104 requiring analysis. These components are organized in a clear format that directs the LLM 110 to compare the known sensitive entities against the provided text context. The prompt structure enables the LLM 110 to understand both what has already been identified and what additional sensitive entities should be sought within the given text segment.

In one or more embodiments, the prompt 108 includes an additional field specifying a predefined set of sensitive entity types that guides the LLM 110's analysis. These entity types may encompass various categories, such as names, dates, contact information, identification numbers, locations, and domain-specific sensitive attributes. The prompt structure begins with the instruction to identify additional sensitive entities, followed by the enumeration of target entity types for focused detection. This enumeration precedes the presentation of known sensitive entities 102 and the portion of input text 104 requiring analysis. The inclusion of predefined entity types provides explicit constraints that shape the LLM 110's search parameters within the given text. Such specificity in the prompt 108 helps ensure the LLM's output 112 aligns with particular privacy requirements or regulatory frameworks while potentially improving the precision of additional sensitive entity identification.

In one or more embodiments, the prompt 108 implements a structured decomposition by incorporating individual atomic questions for a predefined sensitive entity type. An atomic question follows a consistent pattern, asking the LLM 110 to verify completeness of identification for a specific entity type. For example, one atomic question might ask: “Have all person names in the text been identified in the known sensitive entities?”, while another might ask: “Have all dates in the text been identified in the known sensitive entities?” The prompt 108 presents these atomic questions sequentially after listing the known sensitive entities 102 and the portion of input text 104. This granular questioning strategy encourages the LLM 110 to independently perform focused analysis for an entity type. The atomic question structure promotes systematic evaluation and helps prevent oversight by dedicating specific attention to a predefined sensitive entity category. Such decomposition can enhance the thoroughness of additional sensitive entity identification by explicitly prompting type-specific verification against the initial identification results.

The LLM 110 comprises a machine learning model trained on vast quantities of textual data. The LLM 110 accepts natural language input in the form of prompts and generates corresponding natural language output. In the context of sensitive entity de-identification, the LLM 110 receives a prompt containing previously identified sensitive entities along with portions of input text. Through analysis of the provided context and pattern recognition capabilities, the LLM 110 identifies additional sensitive entities that may have been missed during initial de-identification. The LLM 110 leverages deep neural network architectures to process and understand complex relationships within text. Natural language understanding capabilities enable the LLM 110 to recognize sensitive information based on contextual cues and semantic relationships present in the input prompt.

The LLM 110 can be a general-purpose or foundational model pre-trained on a broad corpus of text data. The general-purpose training enables the LLM 110 to process diverse textual input and perform various language understanding tasks without task-specific training. Through exposure to extensive training data, the LLM 110 develops capabilities to recognize patterns, relationships, and contextual nuances within text. These capabilities allow the LLM 110 to identify sensitive entities based on contextual understanding when processing the prompt 108 despite not being specifically trained for de-identification tasks. The foundational nature of the LLM 110 means that the model maintains broad language understanding while operating within the specific context of analyzing the set of entities 102 and input text 104 to generate the output 112 identifying additional sensitive entities.

In one or more embodiments, the LLM 110 comprises a fine-tuned or on-premise model specifically adapted for sensitive entity detection. The fine-tuned LLM undergoes additional training using domain-specific data containing examples of sensitive entities and their contextual patterns. On-premise deployment of the LLM enables processing of sensitive data within controlled environments, addressing privacy and security requirements. The specialized training enhances the LLM 110's ability to process the prompt 108 and identify domain-specific sensitive entities not present in the set of entities 102. Through fine-tuning, the LLM 110 develops increased sensitivity to particular types of private information while maintaining the fundamental capability to analyze relationships between the input text 104 and previously identified sensitive entities. The on-premise architecture ensures that the prompt 108 processing and output 112 generation occur within secure computational boundaries.

The LLM 110 can be implemented using various neural network architectures. A transformer-based architecture represents one implementation, where multiple layers of self-attention mechanisms process the prompt 108 to identify relationships between tokens in the input text 104 and the set of entities 102. Alternative implementations include recurrent neural networks that process text sequentially or hybrid architectures that combine different neural network types. The LLM 110 architecture may incorporate bidirectional encoding to capture context from both directions when analyzing text for sensitive entities. Memory-efficient architectures enable deployment of LLM 110 on systems with limited computational resources while maintaining the ability to generate the output 112. Specific architectural choices can be optimized based on different factors, such as required processing speed, available computational resources, and the nature of sensitive entities being identified. The architecture may also implement sliding window mechanisms to handle long sequences of input text efficiently.

The output 112 comprises the response generated by the LLM 110 upon processing the prompt 108. This output 112 identifies an entity determined by the LLM 110 to be sensitive, where the identified entity was not previously included in the set of entities 102 from the sensitive entity de-identification system 106. The output 112 indicates the sensitive nature of the identified entity through natural language text, structured data, or a combination thereof. Based on this output 112 indicating sensitivity, the identified entity becomes subject to removal during generation of the de-identified text 114. The format and structure of the output 112 can vary depending on the specific implementation while maintaining the core function of identifying additional sensitive entities beyond those in the original set of entities.

An LLM output (e.g., Output 112) comprises a sequence of tokens generated based on a prompt. The output sequence represents the LLM's prediction of likely tokens based on patterns learned during training and context provided in the prompt. Generated tokens may include words, sub words, punctuation marks, or special tokens defined by the LLM's vocabulary. The output format depends on the specific LLM implementation and can range from natural language text to structured data formats. Token generation typically proceeds sequentially, with a new token conditioned on previously generated tokens and the input prompt. The output length may be constrained by maximum token limits or controlled through generation parameters, such as temperature and top-k sampling. Probability distributions over the vocabulary guide token selection at a generation step. The output reflects both general language understanding from pre-training and any specialized knowledge acquired through fine-tuning.

In one or more embodiments, the output 112 comprises structured data formatted in a machine-readable standard, such as JavaScript Object Notation (JSON) or eXtensible Markup Language (XML). The structured format encodes information about the newly identified sensitive entity, including, for example, the entity value, entity type, and/or confidence score associated with the sensitivity determination. JSON or XML formatting enables direct parsing and integration with automated systems that generate the de-identified text 114. The structured output 112 may include additional metadata, such as character offsets indicating the entity's position within the input text 104, contextual indicators supporting the sensitivity determination, or relationships to entities in the original set 102. This machine-readable format facilitates efficient downstream processing through standardized data structures and well-defined schema definitions. Automated systems can extract the relevant entity information from the structured output and apply consistent de-identification procedures across multiple instances of text processing.

In one or more embodiments, the prompt 108 comprises a structured set of atomic questions designed to methodically probe for missed sensitive entities. An atomic question corresponds to a specific sensitive entity type, such as names, dates, or locations, and asks the LLM 110 to verify completeness of identification within at least a portion of the input text 104. The atomic questions systematically compare entities of a type present in the input text 104 against those already identified in the set of entities 102. For an entity type, the output 112 provides a binary completeness indicator along with specific details of any missed instances. When the LLM 110 determines all instances of a particular entity type have been identified, the output 112 confirms completeness for that type. Conversely, when instances are found to be missing, the output 112 enumerates these missed entities to enable comprehensive de-identification. This systematic questioning approach structures the LLM 110's analysis into discrete verification tasks for a sensitive entity type. The atomic nature of the questions enables precise tracking of identification coverage across different types of sensitive information.

A de-identified text 114 represents a processed version of at least a portion of the input text 104. The de-identified text 114 has undergone removal of sensitive entities through a multi-stage identification process. This process encompasses both the set of entities 102 initially detected by the sensitive entity de-identification system 106 and any additional entities identified in the output 112 of the large language model 110. The de-identified text 114 maintains the structural integrity of the relevant portion of the input text 104 while excluding all identified sensitive entities. The resulting text artifact is prepared for persistent storage in a non-transitory, computer-readable medium.

The input text 104 can undergo various transformations to handle sensitive entities, resulting in de-identified text 114. Redaction removes sensitive entities completely, replacing the entities with empty spaces or deletion markers. Masking substitutes sensitive entities with fixed-length character sequences, such as “XXXXX”, or standardized placeholders, like “[REDACTED].” Hashing applies a cryptographic hash function to sensitive entities, generating unique fixed-length strings that preserve referential integrity while obscuring the original values. Relexification replaces sensitive entities with semantically similar but fictitious alternatives, maintaining natural language readability while protecting confidentiality. The specific transformation method can be selected based on downstream requirements, privacy regulations, or application-specific needs. Multiple transformation techniques may be applied in combination to different types of sensitive entities within the same de-identified text 114, providing granular control over information protection levels.

The de-identified text 114 serves as privacy-preserving input for downstream computational tasks. Data analysis operations can extract patterns, trends, or statistical insights from the de-identified text 114 without exposing sensitive information. Machine learning models can be trained on the de-identified text 114 to perform various tasks, such as text classification, sentiment analysis, or topic modeling, while maintaining compliance with privacy requirements. The choice of entity transformation method in generating the de-identified text 114 affects the utility of the text for specific downstream tasks. For example, relexification may better preserve natural language characteristics for NLP models, while hashing may be optimal for maintaining entity relationships in graph-based analyses. The de-identified text 114 enables organizations to leverage valuable textual data for analytical and machine learning purposes while minimizing privacy risks. Multiple instances of de-identified text 114 can be aggregated into larger datasets suitable for training robust machine learning models or conducting comprehensive statistical analyses.

### 3. Entity Type Verification Through LLM Prompting

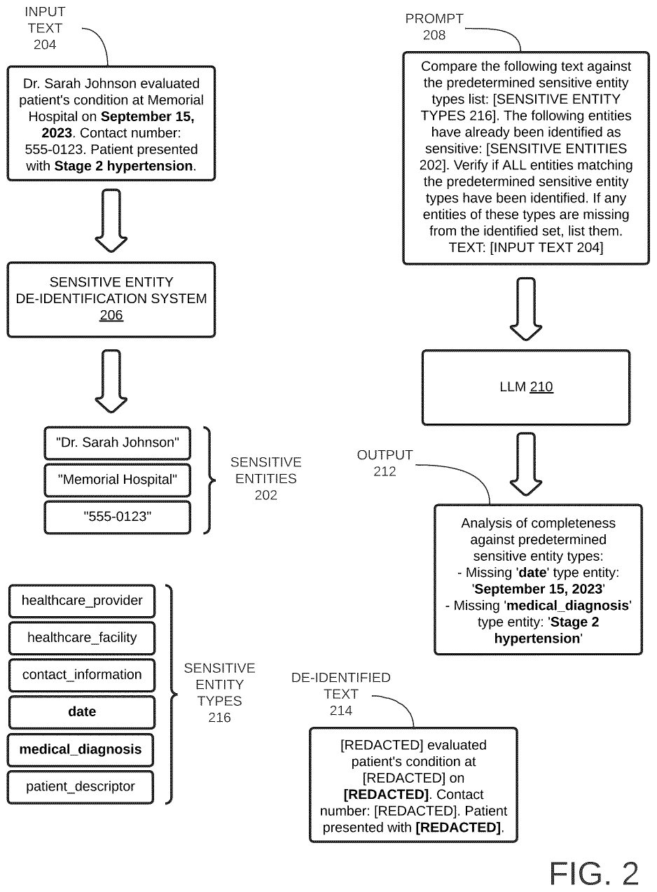

FIG. 2 illustrates sensitive entity type verification through LLM prompting in accordance with one or more embodiments. The technique begins with an input text 204 that undergoes processing by a sensitive entity de-identification system 206. This system identifies a set of entities 202 within the input text as sensitive entities. A prompt 208 is then constructed and sent to an LLM 210. The prompt incorporates both the previously identified set of entities and at least a portion of the input text. Additionally, the prompt 208 includes instructions directing the LLM 210 to evaluate if the set of entities 202 encompasses all entities belonging to a sensitive entity type within a predetermined set of sensitive entity types 216 present in the input text portion. The LLM processes this prompt and generates an output 212. This output identifies at least one additional entity not present in the original set of entities 202, indicating the additional entity as sensitive. Based on this identification, the technique generates a de-identified text (214). The de-identified text comprises a portion of the input text with both the original set of entities and the newly identified sensitive entity removed. The final step involves storing the de-identified text in a non-transitory, computer-readable medium for future use or reference.

In the example of FIG. 2, the input text 204 includes medical information: “Dr. Sarah Johnson evaluated patient's condition at Memorial Hospital on Sep. 15, 2023. Contact number: 555-0123. Patient presented with Stage 2 hypertension.” A sensitive entity de-identification system processes this text and identifies an initial set of entities 202: “Dr. Sarah Johnson,” “Memorial Hospital,” and “555-0123.” A prompt 208 is constructed that includes these identified entities and instructs the LLM 210 to verify completeness against a predetermined set of sensitive entity types 216: healthcare provider, healthcare facility, contact information, date, medical diagnosis, and patient descriptor. The LLM processes this prompt and generates an output 212 identifying two missing sensitive entities: the date “Sep, 15, 2023” and the medical diagnosis “Stage 2 hypertension.” Based on this comprehensive identification, a de-identified text 214 is generated by replacing all sensitive entities with “[REDACTED],” resulting in: “[REDACTED] evaluated patient's condition at [REDACTED] on [REDACTED]. Contact number: [REDACTED]. Patient presented with [REDACTED].” The final de-identified text maintains the structural integrity of the original text while removing all identified sensitive information. This de-identified version is then stored in a non-transitory, computer-readable medium.

The technique and other techniques disclosed herein support multiple approaches for removing sensitive entities from the input text when generating the de-identified text. A first alternative involves using customizable mask tokens, such as “[PHI]”, “***”, or “<confidential>”, to replace identified sensitive entities. A second approach generates unique cryptographic hash values for a sensitive entity, replacing the original text with these hash values while maintaining referential consistency throughout the document. A third technique employs relexification, where sensitive entities are replaced with contextually appropriate substitutes that preserve the semantic structure of the text. For example, “Dr. Sarah Johnson” could be relexified to “Dr. Smith,” “Memorial Hospital” to “Regional Hospital,” and “Sep. 15, 2023” to “Date_1.” The relexification approach maintains readability while obscuring the original sensitive information. These alternative removal strategies can be applied uniformly across all sensitive entity types or selectively based on entity type, compliance requirements, or downstream processing needs. The selection of a specific removal strategy may depend on various factors, such as privacy requirements, data utility preservation, and the intended use of the de-identified text. For instance, hash values might be preferred when it is crucial to maintain entity relationships, while relexification could be optimal when preserving human readability is required.

### 4. Entity Verification and Selective Text Generation

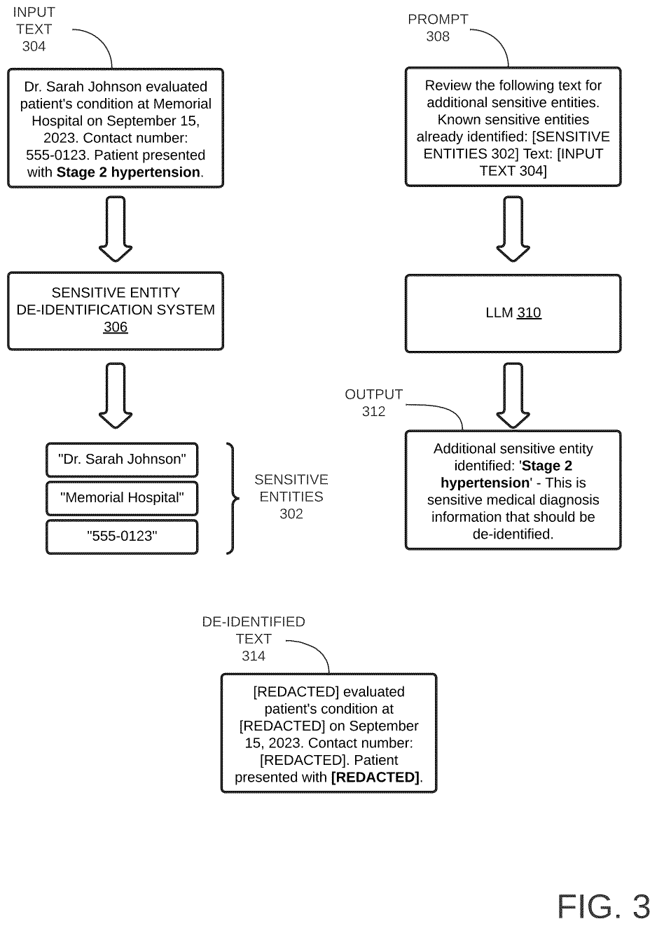

FIG. 3 illustrates entity verification and selective text generation in accordance with one or more embodiments. A sensitive entity de-identification system 306 processes an input text 304 to identify a set of entities 302 as sensitive entities. The technique constructs a prompt 308 comprising the identified set of entities 302 and at least a portion of the input text 304. The prompt 308 is transmitted to an LLM 310 for analysis. The LLM 310 generates an output 312 identifying an additional entity as sensitive, where this additional entity was not included in the original set of entities 302 identified by the sensitive entity de-identification system 306. Upon receiving the output 312, the technique verifies the presence of the additionally identified entity within the input text 304. Following verification, the technique generates a de-identified text 314 by removing both the original set of entities 302 and the newly identified sensitive entity from the relevant portions of the input text 304. The de-identified text 314 is then stored in a non-transitory, computer-readable medium.

The embodiment addresses the potential for LLM hallucinations through a verification step before proceeding with entity removal. After obtaining the LLM output 312 that identifies an additional sensitive entity, the technique explicitly verifies if this entity exists within the input text 304. This verification serves as a computational safeguard against false positives that could arise from LLM hallucinations, where the LLM might generate entities not present in the original text. The verification step ensures that only genuine sensitive entities found in the input text 304 are included in the subsequent de-identification process. By implementing this verification mechanism, the technique maintains data integrity while protecting against erroneous modifications to the text that could result from LLM hallucinations. The generation of de-identified text 314 proceeds only after confirming the presence of the LLM-identified entity in the input text 304, thereby establishing a reliable foundation for the enhanced de-identification process. This systematic approach combines the advanced entity recognition capabilities of the LLM with robust verification procedures to achieve accurate and trustworthy de-identification results.

In the example of FIG. 3, the sensitive entity de-identification system 306 processes an input text 304 containing medical information about a patient visit. The input text 304 reads: “Dr. Sarah Johnson evaluated patient's condition at Memorial Hospital on Sep. 15, 2023. Contact number: 555-0123. Patient presented with Stage 2 hypertension.” The system initially identifies a set of entities 302 comprising three sensitive elements: “Dr. Sarah Johnson,” “Memorial Hospital,” and “555-0123.” A prompt 308 is constructed by combining these identified sensitive entities with the input text 304, requesting the LLM 310 to review the text for additional sensitive entities. The LLM 310 generates an output 312 identifying “Stage 2 hypertension” as an additional sensitive entity, specifically noting that this represents sensitive medical diagnosis information requiring de-identification. The technique verifies that “Stage 2 hypertension” is indeed present in the input text 304. Following verification, the method generates a de-identified text 314 by replacing all sensitive entities with “[REDACTED],” resulting in: “[REDACTED] evaluated patient's condition at [REDACTED] on Sep. 15, 2023. Contact number: [REDACTED]. Patient presented with [REDACTED].” The de-identified text preserves the document's structure while protecting both the initially identified sensitive entities and the LLM-identified medical diagnosis.

As discussed above, the de-identification process supports multiple approaches for handling sensitive entities in the de-identified text 314 including other masks, hashing, and relexification.

### 5. Dual-Pass Entity Validation and Secondary LLM Review

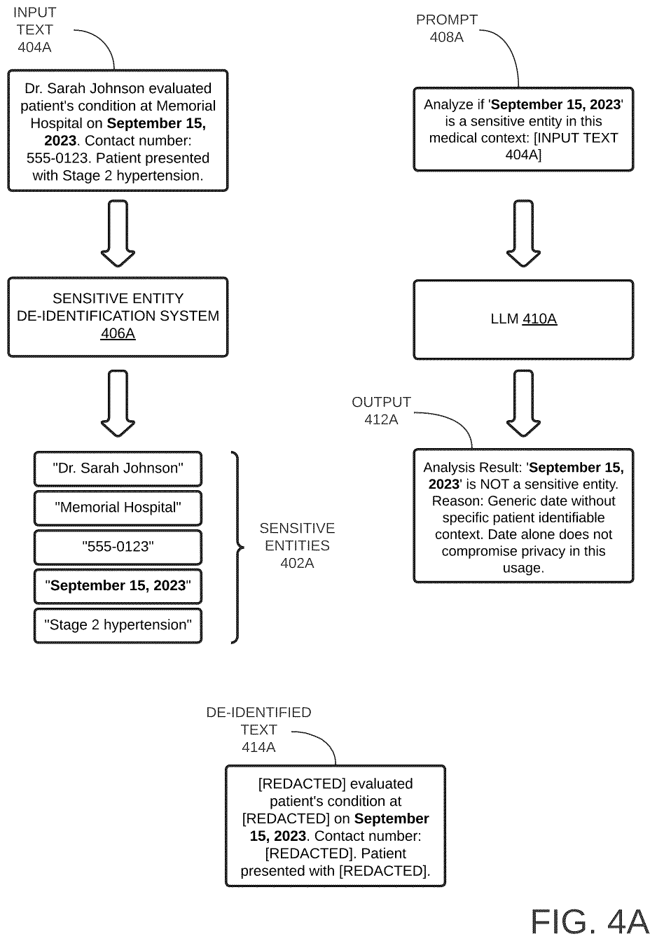

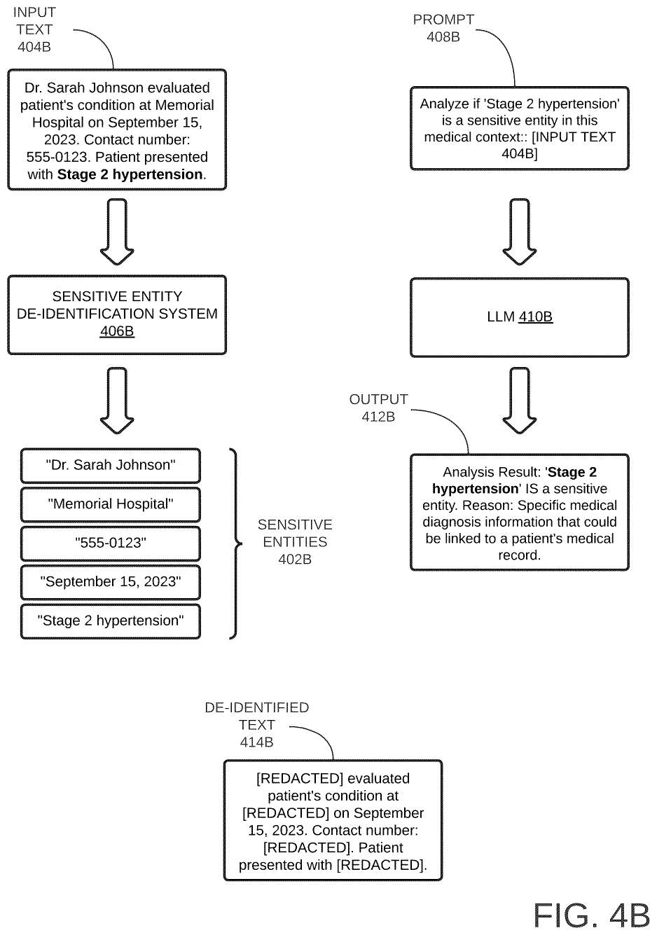

FIG. 4A illustrates dual-pass entity validation with secondary LLM review where an entity is incorrectly identified as sensitive in accordance with one or more embodiments. The input text 404A is processed through a sensitive entity de-identification system 406A that identifies a set of entities 402A as potentially sensitive. A first prompt, generated from the identified set of entities and portions of the input text, is transmitted to an LLM 410A. The LLM analyzes this input and produces output identifying additional sensitive entities not captured in the initial set. A second prompt, 408A, containing a second entity from the original set 402A and a portion of the input text 404A, is also sent to the LLM 410A. The LLM processes this second prompt and generates a second output 412A indicating if the second entity should be classified as sensitive or non-sensitive. Based on these determinations, a de-identified text 414A is generated. This de-identified text 414A excludes confirmed sensitive entities while retaining entities determined to be non-sensitive by the LLM. The final de-identified text is stored in a non-transitory, computer-readable medium for future reference or use.

In the example of FIG. 4A, the sensitive entity de-identification system 406A receives an input text 404A containing medical information: “Dr. Sarah Johnson evaluated patient's condition at Memorial Hospital on Sep. 15, 2023. Contact number: 555-0123. Patient presented with Stage 2 hypertension.” The system 406A initially identifies a set of potentially sensitive entities 402A, including “Dr. Sarah Johnson,” “Memorial Hospital,” “555-0123,” “Sep. 15, 2023,” and “Stage 2 hypertension.” A prompt 408A is constructed to evaluate the sensitivity of the date entity “Sep. 15, 2023” (and potentially others of the entities 402A) within the medical context of the input text 404A. This prompt is sent to the LLM 410A for analysis. The LLM 410A generates an output 412A, determining that “Sep. 15, 2023” is not a sensitive entity, explaining that the date alone does not compromise privacy in this context. Based on this determination, a de-identified text 414A is generated that retains the non-sensitive date while redacting the confirmed sensitive entities. The resulting de-identified text reads: “[REDACTED] evaluated patient's condition at [REDACTED] on Sep. 15, 2023. Contact number: [REDACTED]. Patient presented with [REDACTED].” The selective preservation of the date, while maintaining redaction of sensitive information, demonstrates a capability of one or more embodiments to make nuanced determinations about entity sensitivity.

FIG. 4B illustrates dual-pass entity validation with secondary LLM review where a sensitive entity is confirmed as sensitive in accordance with one or more embodiments. A set of entities 402B previously identified as sensitive entities is received from an initial de-identification process. An input text 404B undergoes processing through the system 406B. A prompt 408B is constructed and comprises an entity (and possibly others of the entities 402B) selected from the set of entities 402B along with at least a portion of the input text 404B. The prompt 408B is then transmitted to an LLM 410B for analysis. The LLM 410B processes the prompt 408B and generates an output 412B. The output 412B provides confirmation that the entity is indeed a sensitive entity. Based on this confirmation from the output 412B, a de-identified text 414B is generated. The de-identified text 414B excludes both the entity and other identified (and possibly confirmed) sensitive entities from the input text 404B. Through this verification process, the accuracy of sensitive entity identification and removal is enhanced. The systematic confirmation of sensitive entities by the LLM 410B improves thorough de-identification of the input text 404B.

In the example of FIG. 4B, an input text 404B is processed by the sensitive entity de-identification system 406B. The input text 404B includes the following medical information: “Dr. Sarah Johnson evaluated patient's condition at Memorial Hospital on Sep. 15, 2023. Contact number: 555-0123. Patient presented with Stage 2 hypertension.” A set of sensitive entities 402B has been previously identified, including “Dr. Sarah Johnson,” “Memorial Hospital,” “555-0123,” “Sep. 15, 2023,” and “Stage 2 hypertension.” A prompt 408B is constructed to verify the sensitivity of one or more entities from this set, for example, asking the LLM 410B to “Analyze if ‘Stage 2 hypertension’ is a sensitive entity in this medical context.” The LLM 410B processes this prompt and generates an output 412B that confirms “Stage 2 hypertension” qualifies as a sensitive entity due to being specific medical diagnosis information that could be linked to a patient's medical record. Based on this confirmation in the second output 412B, a de-identified text 414B is generated where sensitive entities are replaced with “[REDACTED],” resulting in: “[REDACTED] evaluated patient's condition at [REDACTED] on Sep. 15, 2023. Contact number: [REDACTED]. Patient presented with [REDACTED].” This verification process ensures proper identification and redaction of sensitive medical information from the input text.

As discussed above, the de-identification process supports multiple approaches for handling sensitive entities in the de-identified text 414B, including other masks, hashing, and/or relexification.

### 6. Entity Type Reclassification Using Multiple LLM Analysis

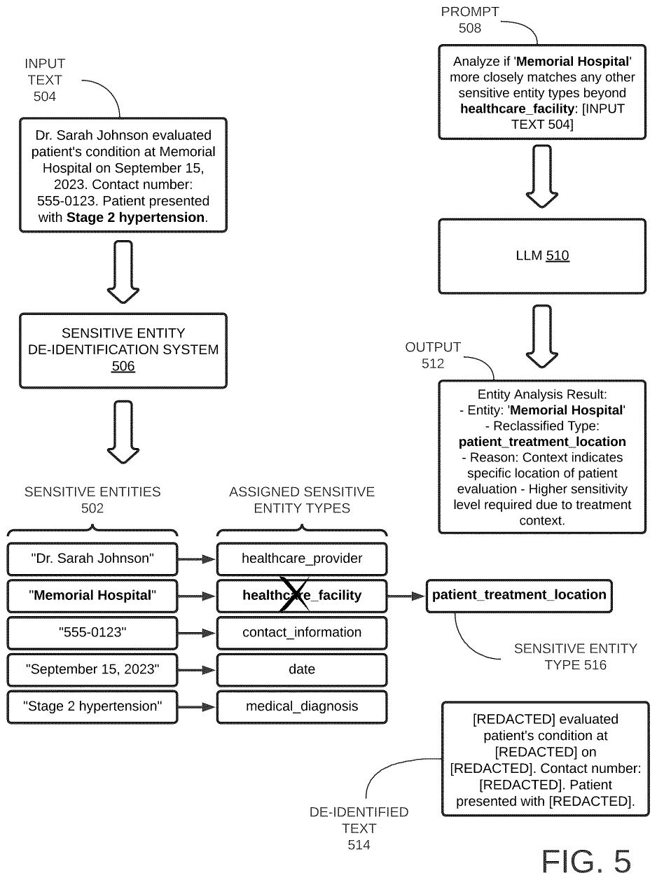

FIG. 5 illustrates entity type reclassification using multiple LLM analysis in accordance with one or more embodiments. An input text 504 is processed through a sensitive entity de-identification system 506 to identify a set of entities (502) that the sensitive de-identified system 506 determined are sensitive entities. A prompt 508 containing an entity from the set of entities and a portion of the input text 504 is transmitted to an LLM 510. The LLM generates an output 512 that indicates the entity belongs to a second predetermined sensitive entity type that differs from a first predetermined sensitive entity type initially assigned to the second entity by the sensitive entity de-identification system 506. Based on this determination, updated sensitive entity de-identification data is stored reflecting the second predetermined sensitive entity type. A de-identified text 514 is generated by removing any identified sensitive entities, including the entity with the updated sensitive entity type. This de-identified text is subsequently stored in a non-transitory, computer-readable medium.

In the example of FIG. 5, an input text 504 containing healthcare information describing a patient evaluation is processed by a sensitive entity de-identification system 506. The input text 504 includes details about the healthcare provider, facility, contact information, date, and medical diagnosis. The sensitive entity de-identification system 506 initially identifies five sensitive entities 502 with corresponding types: “Dr. Sarah Johnson” as healthcare_provider, “Memorial Hospital” as healthcare_facility, “555-0123” as contact_information, “Sep. 15, 2023” as date, and “Stage 2 hypertension” as medical_diagnosis. A prompt 508 is sent to an LLM 510 requesting analysis to determine if “Memorial Hospital” better matches additional sensitive entity types beyond healthcare_facility. The LLM 510's output reclassifies “Memorial Hospital” as patient_treatment_location, providing reasoning that the context indicates a specific location of patient evaluation requiring heightened sensitivity. Based on this reclassification, updated sensitive entity de-identification data is stored reflecting the patient_treatment_location type for “Memorial Hospital”. A de-identified text 514 is generated by replacing all sensitive entities, including “Memorial Hospital” under the updated classification, with “[REDACTED]” markers. The resulting de-identified text 514 maintains the grammatical structure of the original text 504 while removing all identified sensitive information, effectively preserving privacy through comprehensive entity removal.

In one or more embodiments, a structured prompt 508 is employed that explicitly enumerates alternative sensitive entity types for potential reclassification. The prompt 508 specifies candidate types, such as “patient_treatment_location,” “patient_referral_location,” and “clinical_trial_site,” when requesting analysis of “Memorial Hospital.” This explicit enumeration helps constrain the LLM 510's reclassification analysis to a predefined set of entity types relevant to healthcare facilities. The LLM 510 evaluates the contextual usage of “Memorial Hospital” against a specified alternative type. Upon analysis, the LLM 510 determines that “Memorial Hospital” aligns most closely with “patient_treatment_location” based on the surrounding context of input text 504 indicating direct patient care activities. The sensitive entity de-identification data is then updated to reflect this more specific classification. This structured approach to entity type evaluation enhances consistency in sensitive entity classification by providing clear boundaries for the reclassification process. The resulting de-identified text 514 reflects the enhanced sensitivity level associated with the patient_treatment_location classification through appropriate redaction of the facility name.

In one or more embodiments, the prompt 508 comprises multiple atomic questions. An atomic question systematically evaluates the classification accuracy of a specific entity from the identified set: “Dr. Sarah Johnson” as healthcare_provider, “Memorial Hospital” as healthcare_facility, “555-0123” as contact_information, “Sep. 15, 2023” as date, and “Stage 2 hypertension” as medical_diagnosis. The atomic questions present a binary classification verification task to the LLM, followed by a reclassification directive when misclassification is detected. For an entity, the prompt 508 includes the current classification, the relevant portion of input text 504 providing context, and a predetermined set of alternative sensitive entity types for consideration. The LLM 510 processes these atomic questions sequentially, evaluating the contextual appropriateness of an entity's current classification. Upon encountering “Memorial Hospital,” the LLM 510 determines the healthcare_facility classification requires refinement. The LLM 510 then selects patient_treatment_location from the predetermined set of sensitive entity types as the more appropriate classification based on the contextual evidence of direct patient care. This atomic question structure enables precise entity type verification and reclassification while maintaining consistency using predefined sensitive entity types. The sensitive entity de-identification data is updated with the refined classification before generating the final de-identified text.

In one or more embodiments, an enhanced questioning approach is implemented where an atomic question in the prompt 508 presents a ternary classification task to the LLM 510. For an entity in the identified set, the LLM 510 evaluates three possible outcomes: the current sensitive entity type is correct; a different sensitive entity type from the predetermined set is more appropriate; or the entity should not be classified as sensitive based on the contextual usage. This ternary structure allows the LLM 510 to refine classifications and eliminate false positives from the initial sensitive entity detection. The prompt 508 (or an atomic question) provides or references the current classification, the contextual portion of the input text 504, and the predetermined set of alternative sensitive entity types. When processing these questions, the LLM 510 can determine that an initially identified entity requires no redaction due to non-sensitive contextual usage. For example, if “Memorial” appeared in a different context unrelated to healthcare or patient treatment, the LLM 510 could designate the entity as non-sensitive. The sensitive entity de-identification data is then updated to reflect both reclassifications and declassifications before generating the de-identified text 514. This ternary evaluation structure enhances precision in sensitive entity identification by preventing unnecessary redaction of contextually non-sensitive information while maintaining appropriate protection for genuine sensitive entities.

### 7. Precision Measurement and Alert Generation

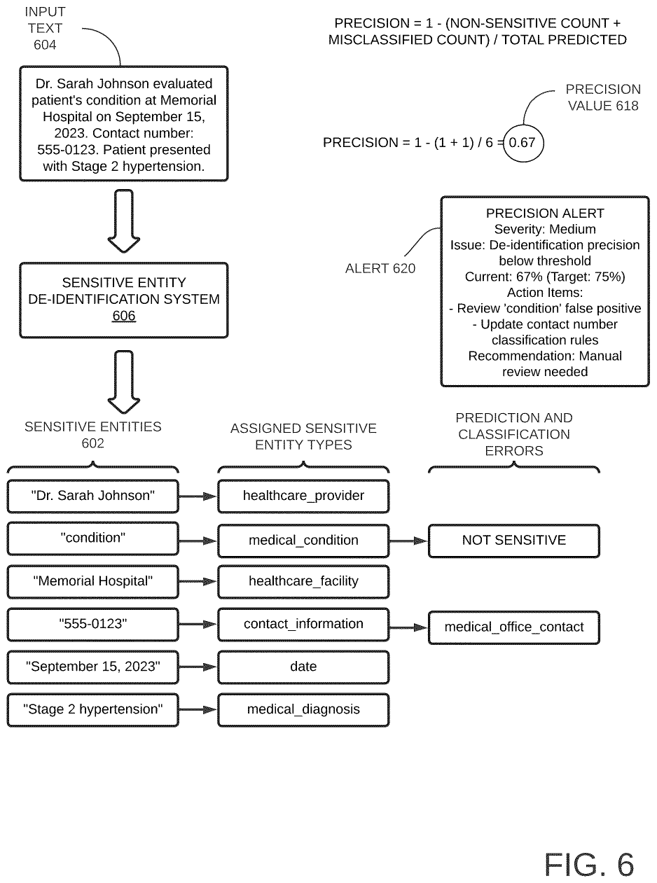

FIG. 6 illustrates precision measurement and alert generation in accordance with one or more embodiments. An input text 604 is processed through a sensitive entity de-identification system 606 that identifies a set of entities 602 as sensitive entities within the input text 604. A sensitive entity de-identification precision value 618 is then calculated using two metrics. The first metric counts entities of the set of sensitive entities 602 incorrectly flagged by the sensitive entity de-identification system 606 as sensitive in the input text 604, determined through LLM prompt analysis of the set of sensitive entities 602 in context of the input text 604. The second metric measures the number of the set of sensitive entities 602 misclassified by the sensitive entity de-identification system 606 by sensitive entity type in the input text 604, also evaluated through LLM prompting based on the set of sensitive entities 602 and the input text 604. When the precision value indicates potential issues, an alert 620 is generated to notify relevant stakeholders. This approach combines initial entity detection with LLM-enhanced verification and precision monitoring to ensure robust de-identification of sensitive information.

In the example of FIG. 6, the ‘condition’ entity is determined by LLM analysis to be misclassified as a sensitive entity in the context of input text 604. The ‘555-0123’ entity is also determined by LLM analysis to be incorrectly classified in the context of input text 604 as content_information, where it is more accurately classified as medical_office_contact.

In one or more embodiments, the sensitive entity de-identification precision value 618 is determined as 1−((X+Y)/Z), accounting for multiple types of identification errors. In this formula, X represents the count of entities within input text 604 that, according to LLM-analysis, the sensitive entity de-identification system 606 incorrectly tagged as sensitive entities. Y denotes the number of actual sensitive entities from input text 604 that, according to LLM-analysis, were correctly identified as sensitive but assigned an incorrect sensitive entity type by system 606. Z equals the total count of entities in set 602 that system 606 identified as sensitive entities. The formula subtracts the error ratio (X+Y)/Z from 1, resulting in a precision value that ranges from 0 to 1. A precision value of 1 indicates perfect precision with no false positives or type misclassifications, while lower values indicate degraded precision. For example, if system 606 identifies 100 entities as sensitive (Z=100), incorrectly flags 5 non-sensitive entities (X=5), and misclassifies the type of 10 actual sensitive entities (Y=10), the precision value would be 1−((5+10)/100) =0.85 or 85%. This mathematical representation enables objective measurement of the system's precision performance.

Alternative formulations for calculating the sensitive entity de-identification precision value 618 can use different mathematical relationships between X, Y, and Z. A ratio (Z−X−Y)/Z provides a direct measure of correctly identified and classified entities relative to total identified entities. Another approach weights the error types differently, such as (Z−αX−βY)/Z, where α and β are configurable or learned parameters that adjust the relative importance of false positive identifications versus type misclassifications. The precision could also be calculated as a geometric mean, √((1−X/Z)(1−Y/Z)), that penalizes significant disparities between the two types of errors. An exponential decay formula, e\hat{ }(−(X+Y)/Z), produces a precision value that decreases more rapidly as errors accumulate. The precision might alternatively be expressed as separate components, with X/Z representing the identification precision and Y/Z representing the classification precision, allowing system operators to monitor these aspects independently. A weighted harmonic mean, 2/((α/1−X/Z)+(β/1−Y/Z)), provides another perspective that balances both error types while allowing for customized weighting. These various mathematical formulations enable system operators to choose a precision calculation that best aligns with specific de-identification requirements and error tolerance thresholds.

The alert generation 620 employs various mechanisms based on the calculated precision value and system requirements. A threshold-based approach triggers the alert when the precision value falls below a predetermined threshold such as 0.95. Other implementations use multiple thresholds to generate different alert severity levels: critical alerts for precision below 0.9, warnings for precision between 0.9 and 0.95, and informational notices for precision between 0.95 and 0.98. The system may generate time-based alerts by monitoring precision value trends, triggering notifications when the precision shows a statistically significant decline over a specified time window. Contextual alert generation considers both the precision value and the sensitivity level of the data being processed, applying stricter thresholds for highly sensitive information, like medical records or financial data. The alerts themselves can take multiple forms: entries in system logs, email notifications to designated administrators, real-time dashboard updates, or API callbacks to integrated monitoring systems. Some implementations incorporate machine learning to adapt alert thresholds based on historical patterns and feedback from system operators. The alert system might also aggregate precision values across multiple processing batches, generating notifications when the moving average indicates a systematic decline in precision performance.

### 8. Recall Value Assessment and Alert System

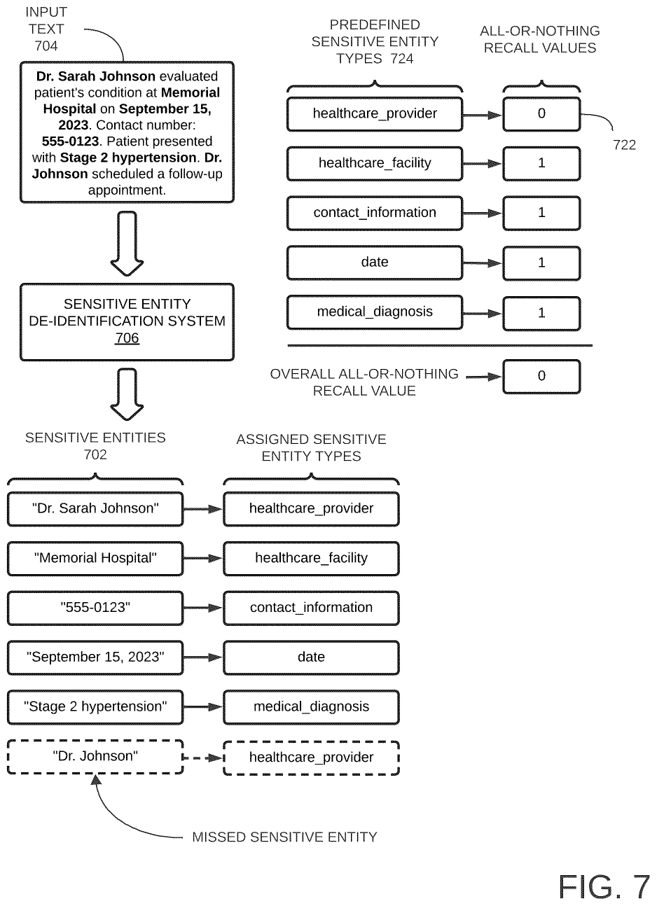

FIG. 7 illustrates recall value assessment and alert system in accordance with one or more embodiments. A sensitive entity de-identification system 706 processes an input text 704 to identify a set of entities 702 as sensitive entities. An all-or-nothing recall value (e.g., 722) for each sensitive entity type within a predetermined set of sensitive entity types 724 is determined. The all-or-nothing recall value is a binary value. One value (e.g., 1) indicates that all instances of a corresponding sensitive entity type in the input text 704 were identified by the sensitive entity de-identification system 706 as reflected by the set of entities 702. The other value (e.g., 0) indicates that not all instances of the corresponding entity type in the input text 704 were identified by the sensitive entity de-identification system 706. In the example of FIG. 7, the sensitive entity de-identification system 706 missed the “Dr. Johnson” instance of the healthcare_provider type. Thus, the overall all-or-nothing recall value for the input text 704 is also negative (e.g., 0) because at least one instance of at least one of the predefined set of types 724 in the input text 704 was missed by the sensitive entity de-identification system 706. Based on the determined recall value 722, an alert is generated when the recall value indicates incomplete identification by the sensitive entity de-identification system 706 of sensitive entities of a sensitive entity type within the input text 704. The alert signifies that at least one instance of at least one of the predetermined sensitive entity types was not identified in the input text 704 by the sensitive entity de-identification system 706.

The alert serves as a notification mechanism triggered by incomplete sensitive entity identification. When the all-or-nothing recall value 722 for a specific sensitive entity type indicates that some instances of that type were not identified in the input text 704 by the sensitive entity de-identification system 706, an alert is automatically generated and issued. This alert functions as a feedback signal, indicating potential gaps in the de-identification process. The alert enables system operators or administrators to take corrective actions, such as reviewing the input text 704 for missed sensitive entities, adjusting the sensitive entity de-identification system 706, or modifying the LLM prompt construction. By monitoring and responding to these alerts, organizations can maintain privacy protection and regulatory compliance in their data handling processes.

The alert can be generated through multiple technical approaches and mechanisms. One implementation involves generating a system-level notification that appears in a graphical user interface, highlighting specific portions of the input text 704 where potential unidentified sensitive entities may exist. Another approach generates the alert as a programmatic callback or event that can be consumed by other system components or external applications. The alert might also manifest as an entry in a system log file, documenting various details, such as the sensitive entity type, the calculated all-or-nothing recall value 722, and relevant portions of the input text 704. Some implementations may generate the alert as an email or message sent to designated system administrators or data privacy officers. The alert could additionally be generated as a structured data object containing metadata about the identified gaps that can be stored in a database for tracking and analysis purposes. Some implementations might generate the alert through a combination of these methods, creating a multi-channel notification system that ensures appropriate stakeholders are informed of potential sensitive entity identification gaps. The alert generation may also include severity levels based on the magnitude of the discrepancy between expected and actual identification rates for the sensitive entity type.

### 9. Method for Automatic De-Identification of Sensitive Data With De-Identification Evaluation

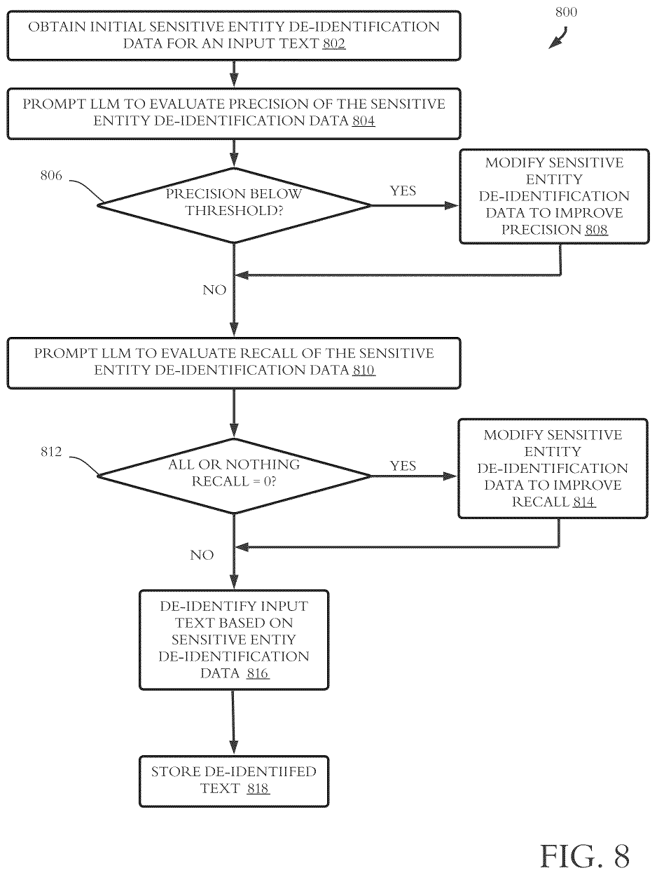

FIG. 8 illustrates a flowchart depicting a method 800 for evaluating and enhancing sensitive entity de-identification using a large language model (LLM) in accordance with one or more embodiments. The method 800 begins with obtaining sensitive entity de-identification data that includes a set of entities identified as sensitive entities in an input text by a sensitive entity de-identification system (Operation 802).

The method 800 then proceeds with a precision evaluation phase, where a first prompt is sent to the LLM containing the input text and the set of entities, obtaining a first LLM output (Operation 804). This first output indicates if any entities from the set are not actually sensitive entities or are misclassified regarding sensitive entity type. The method 800 determines if the first output indicates any such precision issues. When precision issues are identified (Operation 806), the sensitive entity de-identification data is updated to reflect entities that are not sensitive and updated to correct any misclassified sensitive entities (Operation 808).

Following the precision evaluation, the method 800 transitions to a recall evaluation phase. A second prompt containing the input text and the updated set of sensitive entities is sent to the LLM (Operation 810). The second LLM output identifies any sensitive entities present in the input text that were not previously captured in the set of sensitive entities. When additional sensitive entities are found, the sensitive entity de-identification data is updated to include these newly identified sensitive entities

The method 800 concludes with de-identification of the input text based on the final sensitive entity de-identification data (Operation 816), and storing the resulting de-identified text on a non-transitory, computer-readable medium (Operation 818).

In one or more embodiments, the input text comprises structured or unstructured medical data containing sensitive Protected Health Information (PHI), such as patient identifiers, dates, or clinical observations, that require de-identification under HIPAA regulations (Operation 802). In one example, the input text may be extracted from a Fast Healthcare Interoperability Resources (FHIR) patient resource containing demographic information, contact details, and clinical data elements structured according to the FHIR specification. The sensitive entity de-identification system would initially identify PHI elements, like patient names, medical record numbers, and dates of service. When processing FHIR data, the system leverages the standardized resource structure to locate sensitive fields, while method 800 using the LLM helps identify less obvious PHI that may be embedded within free-text notes or comments.

Another example involves processing longitudinal patient records that contain narrative clinical notes, lab results, medication lists, and treatment histories spanning multiple encounters. These records frequently include both explicit identifiers and contextual information that could enable patient re-identification. The LLM's natural language understanding capabilities prove particularly valuable for detecting sensitive entities within the complex temporal and clinical narratives characteristic of longitudinal records. The combination of structured field parsing and LLM-enhanced entity detection provided by the method 800 ensures comprehensive identification of sensitive information across diverse healthcare data formats. This approach is especially useful when processing clinical text that includes medical terminology, abbreviations, and domain-specific references that may inadvertently reveal patient identity through unique combinations of clinical characteristics or rare conditions.

In one or more embodiments, the first prompt sent to the LLM during precision evaluation incorporates a structured set of atomic questions designed to validate each entity's sensitivity classification (Operation 804). For each entity in the initial set identified by the sensitive entity de-identification system, the prompt formulates a discrete question that queries if the entity constitutes a genuine instance of the assigned sensitive entity type within the specific context of the input text. These atomic questions enable granular evaluation of the initial classification decisions. The LLM processes each atomic question independently, leveraging contextual understanding to assess if the entity truly represents sensitive information of the specified type. The LLM output provides a determination for each entity's sensitivity status, coupled with a more nuanced assessment of entity type classification. When the LLM determines an entity has been incorrectly typed, the output specifies a new sensitive entity type that more accurately reflects the entity's role in the input text. For example, an atomic question might ask, “Is the entity ‘Springfield General’ a healthcare facility name in the context: ‘Patient was transferred from Springfield General after stabilization’?” The LLM would confirm the entity's sensitivity while potentially correcting the type from ‘organization name’ to ‘healthcare facility name’. This atomic questioning approach enables precise refinement of the sensitive entity de-identification data by systematically validating both the sensitivity status and type classification of each identified entity. The structured nature of atomic questions facilitates clear, unambiguous responses from the LLM, enhancing the reliability of the precision evaluation phase.

During one or more embodiments of the precision evaluation phase, the LLM output identifies false positives among the initially detected sensitive entities (Operation 804). The LLM analyzes each entity within the specific context provided by the input text to determine if the entity truly constitutes sensitive information requiring de-identification. When entities have been incorrectly flagged as sensitive by the initial de-identification system, the LLM output explicitly indicates these false positive cases. For example, in medical text, a term like “COLD” might be initially flagged as a sensitive medical condition, but the LLM could determine from context that the term actually refers to ambient temperature rather than Chronic Obstructive Lung Disease. Similarly, common names that match patient name patterns might appear in standard medical terminology (e.g., “Baker's cyst” or “Wilson's disease”), and the LLM output would indicate these terms should not be treated as sensitive patient identifiers. The LLM accomplishes this disambiguation by leveraging deep contextual understanding and domain knowledge to differentiate between genuinely sensitive information and benign terms that superficially match sensitive entity patterns. Upon receiving this precision-focused output from the LLM, the system can update the sensitive entity de-identification data by removing these false positive entities, thereby preventing over-redaction in the final de-identified text. This refined entity set better reflects the true sensitive content of the input text, leading to more accurate de-identification results.

In one or more embodiments, the precision calculation quantifies the accuracy of the initial sensitive entity de-identification system by incorporating two distinct types of classification errors. The first error type comprises entities incorrectly identified as sensitive when contextual LLM analysis reveals these entities do not actually constitute sensitive information. The second error type encompasses entities that are correctly identified as sensitive but are assigned incorrect sensitive entity types during the initial classification. The precision metric is derived by examining the ratio of correctly identified and correctly typed sensitive entities to the total number of initially identified sensitive entities. Specifically, the precision calculation subtracts both false positives (non-sensitive entities incorrectly flagged as sensitive) and type misclassifications (sensitive entities assigned incorrect sensitive entity types) from the total count of initially identified entities in the denominator. This comprehensive precision evaluation provides a nuanced assessment of the initial de-identification system's performance. For example, if the system initially identifies 100 entities as sensitive, but the LLM determines that 5 entities are not actually sensitive, and 10 entities are sensitive but incorrectly typed, the precision would be calculated as 85/100 or 85%. This granular approach to precision calculation enables detailed performance analysis of the sensitive entity de-identification system and identifies specific areas for improvement in both sensitivity detection and entity type classification.

In one or more embodiments, an automated precision monitoring mechanism triggers alerts when the calculated precision falls below a predetermined threshold value. This threshold represents the minimum acceptable level of precision for the sensitive entity de-identification system's performance. When the precision calculation, based on both false positive sensitive entities and entity type misclassifications, yields a value lower than the established threshold, the system generates an alert notification. The alert includes detailed information about the precision deficiency, including the specific types of errors contributing to the low precision score. For example, with a threshold set at 90% precision, an alert would be generated if more than 10% of the initially identified entities were either non-sensitive or incorrectly typed. These alerts serve multiple useful functions: flagging potential systematic issues in the de-identification process, enabling timely intervention by system administrators, and providing data for ongoing system optimization. The alert mechanism may be configured to specify if the precision degradation stems primarily from false positive identifications or from entity type misclassifications, enabling targeted improvements to the relevant components of the de-identification system. Additionally, the alert system may include trend analysis capabilities to identify patterns in precision fluctuations over time, supporting proactive system maintenance and refinement of the initial sensitive entity detection algorithms.

In one or more embodiments, a conditional modification strategy for the sensitive entity de-identification data based on precision threshold evaluation is employed (Operation 806). A calculated precision value below the predetermined threshold triggers the modification process, while precision values meeting or exceeding the threshold result in no changes to the sensitive entity de-identification data. When the precision falls below the threshold, the system initiates targeted modifications based on the LLM's precision evaluation output. These modifications include removing entities incorrectly identified as sensitive and updating entity type classifications for misclassified sensitive entities. For example, with a threshold set at 95% precision, if the calculated precision is 92%, the system would proceed with the modification process, incorporating the LLM's recommendations for entity removal and type reclassification. Conversely, if the calculated precision is 96%, the system maintains the original sensitive entity de-identification data without modifications. This threshold-based approach ensures that modifications to the sensitive entity de-identification data occur when necessary, preventing unnecessary adjustments to adequately performing classifications. The conditional modification strategy helps maintain system stability by avoiding modifications when the precision meets acceptable standards while enabling targeted improvements when precision falls below the designated threshold.

In one or more embodiments, a second prompt configuration enhances the recall evaluation phase by incorporating a structured set of atomic questions (Operation 810). The prompt presents one atomic question per sensitive entity type from a predetermined set of sensitive entity types. Each atomic question queries the LLM to assess if complete identification of all instances of a specific sensitive entity type has been achieved within the input text based on the current set of identified entities. The LLM processes these atomic questions and generates binary all-or-nothing recall values for each sensitive entity type. These recall values indicate if comprehensive identification has been achieved for each respective sensitive entity type. When the LLM determines that one or more instances of a sensitive entity type remain unidentified, the LLM output explicitly enumerates these missed entities. The atomic question structure promotes systematic evaluation of recall performance across different sensitive entity types. This methodical approach enables precise identification of gaps in the sensitive entity detection process. The granular feedback provided by the LLM facilitates targeted improvements to the overall de-identification system. By decomposing the recall evaluation into type-specific atomic questions, the system maintains clear traceability between missed entities and their corresponding sensitive entity types.

In one or more embodiments, individual all-or-nothing recall values across the predetermined sensitive entity types are aggregated to compute an overall all-or-nothing recall value for the input text (Operation 812). This aggregation follows a binary logic where the overall recall value becomes zero, false, or negative (or the like) if any individual all-or-nothing recall value indicates a missed sensitive entity of any type. The system assigns a positive overall recall value of one or true (or the like) when the LLM analysis confirms complete identification of all instances across every sensitive entity type in the predetermined set. This aggregation strategy ensures that partial success in entity identification does not mask incomplete coverage of any specific entity type. The binary nature of the overall recall value provides an unambiguous indicator of comprehensive sensitive entity identification success. Such an evaluation criterion aligns with security and privacy requirements where any missed sensitive entity represents a potential vulnerability. The overall recall value serves as a clear completion signal, enabling automated quality control of the de-identification process.

In one or more embodiments, an alert mechanism triggered by negative overall all-or-nothing recall values is implemented. When an overall recall value of zero, false, or negative (or the like) is detected, indicating at least one missed sensitive entity, an automated alert is generated. This alert includes detailed information about the missed sensitive entities and their corresponding entity types as identified by the LLM analysis. The alert mechanism enables rapid response to incomplete de-identification scenarios, facilitating immediate corrective actions. Alert recipients may include system administrators, privacy officers, or other designated stakeholders responsible for ensuring comprehensive sensitive entity detection. The alert delivery can occur through various channels, such as email notifications, system logs, or dedicated monitoring dashboards. This proactive notification approach strengthens the system's ability to maintain high standards of privacy protection by ensuring timely awareness of potential sensitive information exposure risks. The alert system serves as a useful feedback loop in the de-identification quality assurance process.

In one or more embodiments, an automated refinement process is triggered by negative overall all-or-nothing recall values (Operation 812). Upon detecting an overall recall value of zero, false, or negative (Operation 812), the sensitive entity de-identification data is updated to incorporate the missed sensitive entities identified by the LLM analysis (Operation 814). This modification process enhances the coverage of the de-identification data by adding previously undetected entities while preserving their proper entity type classifications. A comprehensive audit trail of these modifications is maintained, tracking each entity addition and the corresponding LLM analysis that prompted the update. Such systematic refinement ensures the sensitive entity de-identification data evolves to capture increasingly complete sets of sensitive entities.

In one or more embodiments, the modification process operates within a feedback loop, where each update potentially triggers re-evaluation of the overall recall value to confirm improved coverage. This iterative enhancement mechanism strengthens the robustness of the de-identification system by continuously incorporating newly discovered sensitive entities. The refined sensitive entity de-identification data then serves as the basis for subsequent de-identification operations, ensuring improved recall in future processing of similar input texts.

In one or more embodiments, a comprehensive de-identification procedure is executed based on the refined sensitive entity de-identification data (Operation 816). The input text is processed, identifying and removing or replacing sensitive entities according to the finalized sensitive entity de-identification data. The finalized sensitive entity de-identification data reflects both precision and recall improvements from the LLM analysis. The de-identification process may employ various transformation techniques, such as entity removal, replacement with generic placeholders, or substitution with pseudonymized values, while maintaining the semantic structure of the surrounding text. Following successful de-identification, the de-identified text is stored in a non-transitory, computer-readable medium, such as a secure database, encrypted file system, or other durable storage mechanism (Operation 818). This storage operation ensures the de-identified text remains available for subsequent processing or analysis while maintaining the privacy protections established through the enhanced de-identification process. The stored de-identified text represents the final output of the multi-stage de-identification pipeline, incorporating all refinements derived from both the precision and recall evaluation phases. The persistence of the de-identified text enables downstream applications to process the data without risk of exposing sensitive information, while the original sensitive entities remain protected through the comprehensive de-identification transformations.

In one or more embodiments, one or more transformation strategies are used to de-identify sensitive entities within the input text (Operation 816). These strategies include complete removal of sensitive entities, masking through character substitution (e.g., replacing characters with asterisks or X's), generation of cryptographic hash values unique to each entity, and relexification where entities are replaced with semantically similar but non-sensitive alternatives. The choice of transformation strategy may vary based on the sensitive entity type, downstream processing requirements, or configurable policy settings. For example, personal names might undergo relexification to maintain readability while medical identifiers could be replaced with hash values to ensure traceability. The system may also apply different strategies to different instances of the same entity type based on context or position within the text. Masking operations preserve the original length and structure of sensitive entities while obscuring the actual content. Hash value replacements provide consistent pseudonymization across multiple occurrences of the same sensitive entity. Relexification maintains the natural flow and grammatical structure of the text by substituting linguistically appropriate alternatives. The combination of these transformation techniques enables flexible and context-aware de-identification while preserving necessary textual characteristics for downstream applications.

In one or more embodiments, a prompt transmission to and output reception from a LLM may involve a multi-layered system architecture facilitating bidirectional communication. The process initiates when a prompt is received by an agent system, which functions as an intermediary interface layer between a client that sends the prompt and the core LLM. This agent system preprocesses the incoming prompt through several potential steps: tokenization of the raw text input, application of any relevant system prompts or context windows, and formatting of the payload according to the LLM's expected input schema. The formatted prompt is then transmitted to the LLM's inference endpoint, via API calls over secure network protocols. The LLM processes the input through its transformer (or other suitable) architecture and generates a response, which is returned to the agent system. The agent system then post-processes this output—potentially filtering, formatting, or additional context—before delivering it back to the client. Throughout this process, the agent system may maintain state information about the conversation, manage authentication and rate limiting, log interactions, and handle error conditions. The agent can also implement various control mechanisms such as prompt injection protections, output moderation, and response validation. This architectural pattern allows for sophisticated interaction patterns while abstracting the complexity of direct LLM communication from clients.

### 10. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

The following is an example of a prompt template used in one or more embodiments to determine the prompt of the precision evaluation stage of the method 800 (Operation 804). The line numbers are for purposes of providing a clear example in this disclosure and are not necessarily part of the template itself.
01: You are a medical de-identification specialist. You are given a medical text and a dictionary of entities extracted by a de-identifier from that medical text.
02:
03: Your task is to answer the following questions based on the given medical text:
   04:
05: Output Format:
06:
07: You must only answer a tuple: (“Y”, “”), (“N”, <correct_entity_type>), (“NOT_PHI”, “OTHER”) as yes, no, or not a PHI entity and the correct entity type if the answer is no. You must output a json dictionary containing all questions as keys and their answers as values.

08:
09: You must answer “Y” if the entity is an instance of an asked entity type. Just answer “N” if the entity type is not an instance of the asked entity_type. The correct entity_type must only be from one of the entity types mentioned in the questions. Do not create new entity types.
10:
11: For example:
12: Is “Rick” an instance of “PERSON” entity type? (“Y”,“”)
13: Is “hand” an instance of “LOCATION” entity type? (“NOT_PHI”, “OTHER”)
14: Is “once a day” an instance of “FREQUENCY” entity type? (“Y”, “”)
15: Is “2 years” an instance of “DURATION” entity type? (“Y”, “”)
16: Is “wife” an instance of “MARITAL_STATUS” entity type? (“Y”, “”)
17: Is “she” an instance of “PERSON” entity type?”: [“NOT_PHI”, “OTHER”]
18: Is “daughter” an instance of “PARENTHOOD” entity type?”: [“Y”, “ ”]
19:
20: Here is the medical text:
21: {medical_text}
22:
23: Questions:
24: {questions}

In one or more embodiments, this prompt template structures the precision evaluation phase for medical text de-identification by establishing a specialized role and clear evaluation framework for the LLM. The template begins by positioning the LLM as a medical de-identification specialist, providing context for the analysis of medical text and extracted entities. Lines 05-07 specify a strict output format requiring JSON dictionary responses with tuple values indicating entity classification correctness. The tuples follow a structured format of (“Y”, “”), (“N”, <correct_entity_type>), or (“NOT_PHI”, “OTHER”), enforcing consistent response patterns for confirmed entities, misclassified entities, and non-PHI entities, respectively. Lines 09-10 establish validation rules, requiring affirmative (“Y”) responses for correct entity type matches and negative (“N”) responses for incorrect classifications, while restricting entity type assignments to predefined categories. Lines 11-18 provide concrete examples demonstrating the expected response format across various entity types, including PERSON, LOCATION, FREQUENCY, DURATION, MARITAL_STATUS, and PARENTHOOD. The template reserves placeholders for the medical text {medical_text} and specific questions{questions} at lines 20-24, enabling dynamic prompt generation based on the input text and entities under evaluation. This structured approach ensures systematic evaluation of entity classification precision while maintaining consistent terminology and response formats throughout the analysis process.

The following is an example of a prompt template used in one or more embodiments to determine the prompt of the recall evaluation stage of the method 800 (Operation 810). The line numbers are for purposes of providing a clear example in this disclosure and are not necessarily part of the template itself.
01: You are a medical de-identification specialist. You are given a medical text and the PHI entities extracted by a deidentifier from that medical text.
02: Your task is to answer the following questions based on the given medical text:
03:
04: Output Format:
05: You must only answer a tuple: (“Y”, [ ]), (“N”, <list_of_missed_entities_for_the_entity_type>) as yes, no, and the list of entities not yet extracted for the entity type if the answer is no.
06: You must output a json dictionary containing all questions as keys and their answers as values.
07: You must answer “Y” if the de-identifier has extracted all possible instances of the entity_type from the medical text.
08: Answer “N” if the de-identifier missed extracting some instances of the asked entity_type followed by the list of missed instances.
09: Do not create new entity types.
10: For example:
11: Have all instances of “PERSON” entity type been extracted? (“N”, [“Rick”, “Morty”])
12: Have all instances of “AGE” entity type been extracted? (“Y”, [ ])
13:
14: Here is the medical text:
15: {medical_text}
16:
17: Extracted Entities:
18: {entities}
19:
20: Questions:
21: {questions}
22:
23: Pay attention to the examples for special cases.

In one or more embodiments, this example prompt template establishes the framework for the recall evaluation phase in medical text de-identification by defining explicit roles and response requirements for the LLM. The template begins by assigning the LLM the role of a medical de-identification specialist tasked with evaluating PHI entity extraction completeness. Lines 04-06 specify a strict output format requiring JSON dictionary responses with tuple values, where each tuple includes either a confirmation of complete extraction (“Y”, [ ]) or identification of missed entities (“N”, [list_of_missed_entities]). Lines 07-09 establish clear evaluation criteria, mandating affirmative responses when all instances of an entity type have been extracted and require explicit enumeration of missed instances for negative responses, while constraining responses to predefined entity types. Lines 10-12 provide concrete examples demonstrating the expected response format, including both complete extraction scenarios and cases with missed entities. The template includes placeholders for the medical text {medical_text}, already extracted entities {entities}, and specific questions {questions} at lines 14-21, enabling dynamic prompt generation based on the current state of entity extraction. Line 23 adds a note emphasizing attention to special cases, ensuring thorough evaluation of edge cases in entity identification. This structured approach ensures comprehensive evaluation of entity extraction completeness while maintaining consistent response formats throughout the analysis process.

### 11. Practical Applications, Advantages, and Improvements

One or more embodiments enable robust de-identification across diverse domains where sensitive information protection is useful. In healthcare settings, one or more embodiments enhance the de-identification of electronic health records (EHRs) by detecting subtle references to patient identifiers, medical conditions, and treatment details that traditional rule-based systems might miss. Financial institutions can apply the method to transaction records and customer communications, ensuring comprehensive removal of account details, financial indicators, and personal identifiers while maintaining document utility. Legal document processing benefits from the method's ability to identify and protect named entities, case references, and confidential details across various document types, including contracts, court filings, and correspondence. Human resources departments can leverage the method to sanitize employment records, performance reviews, and internal communications of sensitive personal and organizational information. Research institutions can apply the method to study data, ensuring participant privacy while preserving research value through appropriate de-identification transformations. The precision and recall evaluation capabilities of one or more embodiments make the system particularly valuable for regulatory compliance, such as HIPAA in healthcare or GDPR in general data protection. Government agencies can utilize one or more embodiments for processing classified documents, ensuring sensitive information remains protected when documents are prepared for public release or inter-departmental sharing. The ability of one or more embodiments to learn from LLM analysis makes the system adaptable to emerging privacy requirements and new types of sensitive information across these various applications.

One or more embodiments provide significant advantages in sensitive entity de-identification through systematic precision and recall optimization. By leveraging LLM capabilities, one or more embodiments identify subtle contextual references and nuanced expressions of sensitive information that traditional rule-based or pattern-matching systems frequently miss. The two-phase evaluation process, addressing both precision and recall, reduces both false positives and false negatives in sensitive entity detection. The atomic question structure in the recall evaluation phase enables granular assessment of entity coverage across different sensitive entity types, ensuring comprehensive identification. The overall all-or-nothing recall metric provides unambiguous quality assurance, while the alert mechanism enables prompt intervention when sensitive entities remain undetected. The ability of one or more embodiments to automatically refine sensitive entity de-identification data based on LLM analysis creates a self-improving system that becomes more robust over time. The flexible transformation strategies—including removal, masking, hashing, and relexification—enable context-appropriate de-identification while maintaining necessary document utility. The automated approach of one or more embodiments scale efficiently to handle large volumes of text while maintaining consistent de-identification quality. Integration of LLM capabilities allows one or more embodiments to adapt to new expressions and variations of sensitive information without requiring manual rule updates. The comprehensive audit trail of modifications and transformations of one or more embodiments supports compliance documentation and system validation requirements. Storage of de-identified text in non-transitory, computer-readable media ensures persistent availability while maintaining privacy protections for downstream applications.

One or more embodiments address limitations of prior art de-identification systems through several technical innovations. Traditional rule-based systems rely on predefined patterns and dictionaries, failing to capture contextual nuances and novel expressions of sensitive information, while one or more embodiments leverage LLM capabilities to understand semantic context and identify sensitive entities based on meaning rather than rigid patterns. Prior systems typically operate in a single pass, leading to missed entities or misclassifications, whereas the two-phase evaluation of one or more embodiments systematically addresses both precision and recall through separate LLM analyses. The atomic question approach for recall evaluation represents a structured methodology for comprehensive coverage assessment, surpassing the ad-hoc evaluation methods of traditional systems. Earlier de-identification systems lack effective feedback mechanisms, while this automated refinement process of one or more embodiments, triggered by negative recall values, creates a self-improving system that learns from LLM insights. Conventional systems often employ uniform transformation strategies across all sensitive entities, but the flexible combination of one or more embodiments of removal, masking, hashing, and relexification enables context-aware de-identification that better preserves document utility. Traditional systems typically lack systematic quality assurance mechanisms, whereas the all-or-nothing recall metric and alert system of one or more embodiments ensures rigorous privacy protection standards. Traditional systems struggle with emerging sensitive entity types and expressions, but the LLM-based approach of one or more embodiments adapts to new patterns without requiring manual updates to rules or dictionaries. The approach to precision and recall optimization of one or more embodiments represents a significant advancement over existing de-identification technologies, particularly in handling complex, nuanced expressions of sensitive information in natural language text.

### 12. Example LLM Architecture

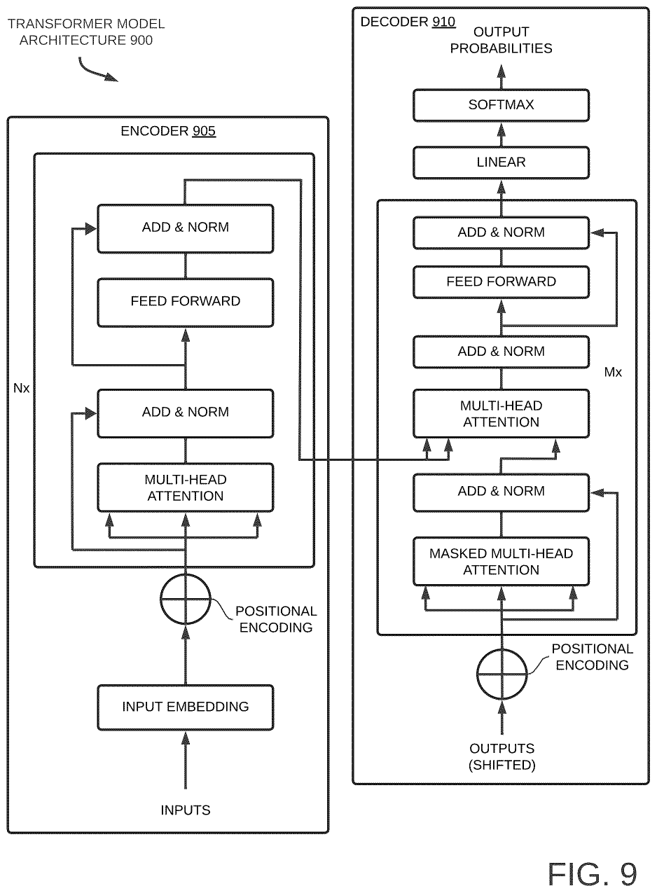

FIG. 9 illustrates an example transformer model architecture 900 that may be used in the implementation of a LLM, such as LLM 110, 210, 310, 410, or 510 described above with respect to the figures, according to an embodiment of the present disclosure.

The transformer model architecture 900 may be a neural network design for natural language processing. At its core, the transformer 900 may encompass an encoder 905 and a decoder 910, both leveraging self-attention mechanisms. The architecture 900 may begin with an input embedding layer that converts tokens into high-dimensional vector representations that may range, for example, from 128 to 1024 dimensions. These embeddings may be augmented with positional encodings to retain sequence order information.

The transformer model architecture 900's input embedding layer serves as the initial processing stage for converting discrete tokens into continuous vector representations. These dense embeddings may occupy a high-dimensional space, with dimensionality configurations ranging from 128 to 1024, allowing for rich semantic representation of input tokens. The embedding process maps each token to a unique vector that captures the token's semantic properties in the continuous space. Positional encodings are subsequently added to these token embeddings through element-wise addition, introducing position-dependent signals that encode sequential information. These positional encodings can be implemented using sinusoidal functions or learned parameters, enabling the model to differentiate between tokens based on their positions in the sequence. The combined embeddings preserve both semantic content and sequential order, forming a foundation for the subsequent self-attention mechanisms. This embedding strategy addresses the inherent limitation of transformer architectures in processing sequential data, as the self-attention mechanism alone is position-agnostic.

The transformer 900 may include a multi-head, self-attention mechanism. This may allow the model 900 to simultaneously attend to different parts of the input sequence, capturing various types of relationships and dependencies. Each attention head may compute query, key, and value vectors, enabling the model to focus on relevant parts of the input when processing each token. Following the attention layers, the architecture 900 may incorporate feed-forward neural networks with multiple layers and non-linear activation functions.

The multi-head self-attention mechanism forms a component of the transformer architecture 900, enabling parallel processing of input sequence elements. Each attention head operates as an independent attention mechanism, computing three distinct matrices: queries (Q), keys (K), and values (V) through learned linear transformations of the input embeddings. The parallel nature of multiple attention heads allows the model to capture diverse relationship patterns within the same input sequence simultaneously, such as syntactic dependencies, semantic relationships, and long-range contextual connections. The attention computation follows the scaled dot-product attention formula, where the dot product between queries and keys determines alignment scores, followed by scaling and softmax normalization to produce attention weights. These weights are then applied to the value vectors, creating context-aware representations. The feed-forward neural networks following the attention layers consist of two linear transformations with a non-linear activation function (e.g., ReLU or GELU) between them, processing each position's output independently. This combination of self-attention and position-wise feed-forward networks enables the model to alternate between gathering contextual information across the sequence and applying complex transformations to individual positions, creating a powerful mechanism for sequence processing.

A masked, multi-head attention mechanism in the decoder 910 of a transformer model 900 may be designed to prevent the model from attending to future tokens during sequence generation. In this mechanism, multiple attention heads may operate in parallel, each computing query (Q), key (K), and value (V) matrices from the input embeddings. The attention scores may be calculated as the dot product of Q and K, scaled by the inverse square root of the dimension of the keys. A lower triangular mask may be applied to these attention scores before softmax normalization, effectively setting the upper triangular elements to negative infinity. This masking may ensure that each position can only attend to previous positions in the sequence, maintaining the autoregressive property of the decoder. The masked attention scores may then be used to compute a weighted sum of the value vectors. The outputs from the heads may be concatenated and linearly transformed to produce the attention output. This process may allow the decoder to generate tokens sequentially while considering only the previously generated tokens, thus preserving the causal nature of language modeling.

The masked multi-head attention mechanism in the transformer's decoder 910 implements causal masking to enforce autoregressive generation during sequence processing. Each attention head performs linear projections to create query (Q), key (K), and value (V) matrices from input embeddings through learned weight matrices WQ, WK, and WV respectively. The attention computation follows the formula Attention (Q, K, V)=softmax(QK^{T}/√dk)V, where dk represents the dimensionality of the key vectors. A lower triangular mask matrix gets added to the attention scores before softmax normalization. This mask sets all upper triangular elements to negative infinity (−∞), effectively zeroing out these positions after the softmax operation. The masking operation ensures strict causality by preventing any position from attending to future positions in the sequence during both training and inference. Following the masked attention computation, the outputs from multiple attention heads are concatenated along the feature dimension and projected through a final linear transformation WO to produce the layer's output. This output maintains the temporal causality required for autoregressive generation while still allowing each position to attend to all previous positions in the sequence. The parallelized implementation of multiple attention heads enables the model to capture various aspects of the sequence history simultaneously, while the masking mechanism maintains the sequential nature of language generation.

To maintain stable training and mitigate vanishing gradients, the transformer 900 may employ layer normalization after each sub-layer (self-attention and feed-forward networks) and may introduce residual connections. These residual connections may allow unimpeded information flow through the network. The model may consist of multiple (Nx) encoder and decoder (Mx) layers stacked on top of each other, increasing its capacity to learn complex language patterns.

The transformer architecture incorporates stabilization techniques through layer normalization and residual connections. Layer normalization is applied after both the self-attention and feed-forward network sub-layers, normalizing the activations across the feature dimension for each token position. The normalization process computes the mean and variance of the features, then scales and shifts the normalized values using learned parameters gamma and beta, effectively standardizing the feature distributions throughout the network. Residual connections, implemented as skip connections, add the input of each sub-layer to the transformed output, creating direct paths for gradient flow during backpropagation. The combination of these components follows the formula LayerNorm(x+Sublayer(x)), where x represents the input and Sublayer represents either the self-attention or feed-forward network.

The stacking of multiple encoder and decoder layers increases the model's capacity logarithmically with respect to sequence length, enabling the capture of hierarchical patterns in language. Each additional layer in the stack provides an opportunity for more abstract feature representation, with lower layers capturing local patterns and higher layers learning more complex, global dependencies. The interaction between layer normalization and residual connections creates a well-conditioned optimization landscape, facilitating stable training of deep transformer networks while mitigating the vanishing gradient problem that commonly affects deep neural architectures.

The output layer may involve a linear transformation followed by a softmax function, producing probability distributions over the vocabulary for text generation tasks. This architecture 900's design may allow for efficient parallel processing of input sequences, making it particularly suitable for handling the extensive datasets used in training LLMs.

The output layer of the transformer architecture implements a vocabulary-sized classification mechanism through a linear transformation followed by softmax activation. The linear transformation projects the decoder's hidden states onto a vocabulary-sized space using a weight matrix W∈ [symbol] \hat{ }(d_model×|V|), where d_model represents the model's hidden dimension and |V| represents the vocabulary size. The subsequent softmax function normalizes these logits into a proper probability distribution across the entire vocabulary, computing P(token_i)=exp(z_i)/Σ_j exp(z_j), where z_i represents the logit for the i-th vocabulary token. This architectural design enables efficient batch processing of input sequences through matrix multiplications, leveraging modern hardware accelerators like GPUs and TPUs. The parallel computation capability stems from the self-attention mechanism's ability to process all sequence positions simultaneously during the forward pass, requiring only O(1) sequential operations compared to the O(n) operations needed in recurrent architectures. The model's parallelization efficiency scales particularly well with increasing sequence lengths, making the architecture advantageous for processing the extensive datasets used in large language model training, which often contain billions of tokens across diverse domains and languages.

In one or more embodiments, architectural variations enhance or modify the standard transformer design for LLM implementations. The Sparse Transformer introduces structured sparsity patterns in the attention mechanism, reducing the quadratic memory complexity to linear complexity through fixed attention patterns. This modification enables processing of much longer sequences while maintaining model quality. Reformer architectures employ locality-sensitive hashing for attention computation, approximating full attention while significantly reducing memory requirements. The Performer architecture replaces the attention mechanism with kernel-based formulations using random feature decomposition, achieving linear complexity in both compute and memory.

Alternate positional encoding schemes offer various trade-offs. Rotary positional embeddings (RoPE) inject positional information through rotation matrices applied to token embeddings, providing better relative position modeling. Alibi position embeddings add learned bias terms to attention scores, enabling better extrapolation to sequences longer than those seen during training. Some architectures eliminate explicit positional encodings entirely, instead relying on position-aware linear attention mechanisms.

Architecture modifications also target specific computational bottlenecks. Flash Attention optimizes attention computation through careful management of GPU memory access patterns. Mixture of Experts (MoE) architectures incorporate specialized sub-networks activated based on input patterns, increasing model capacity without proportional computation increases. The GLU (Gated Linear Unit) variants replace standard feed-forward networks with gated mechanisms, providing more flexible function approximation. Multi-query attention reduces memory bandwidth requirements by sharing key and value projections across attention heads while maintaining separate query projections.

Some architectures focus on improved training dynamics. DeepNorm modifies the layer normalization scheme to enable stable training of deeper networks. Gradient checkpointing strategies reduce memory requirements during training by recomputing certain activations during backpropagation. State space models offer an alternative to attention mechanisms entirely, using linear state space equations to model sequence relationships with improved computational efficiency.

Alternative architectures for LLM implementation encompass distinct paradigms beyond transformers. Recurrent Neural Networks (RNNs), particularly variants like Long Short-Term Memory (LSTM) networks and Gated Recurrent Units (GRUs), process sequences sequentially through hidden state updates. These architectures maintain explicit temporal dependencies through gating mechanisms, controlling information flow between timesteps. LSTM networks employ three gates—input, forget, and output—along with a memory cell to regulate information persistence. GRUs simplify this structure with reset and update gates while maintaining comparable performance.

Convolutional Neural Networks (CNNs) offer another approach through hierarchical feature extraction. Temporal Convolutional Networks (TCNs) apply dilated convolutions to capture long-range dependencies while maintaining autoregressive properties. The hierarchical structure of TCNs enables parallel processing within each layer while preserving causal relationships. Quasi-Recurrent Neural Networks (QRNNs) combine convolutional and recurrent approaches, using convolution for parallel feature extraction followed by a lightweight recurrent pooling mechanism.

Memory-augmented architectures present another paradigm. Neural Turing Machines (NTMs) and Differentiable Neural Computers (DNCs) supplement neural processing with external memory arrays, accessed through attention-like mechanisms. These architectures separate computation from memory storage, enabling more explicit modeling of long-term dependencies. Memory Networks similarly incorporate dedicated memory components but with more structured addressing mechanisms.

Continuous-time models offer an alternative perspective on sequence processing. Neural Ordinary Differential Equations (Neural ODEs) model sequence evolution as a continuous-time dynamical system, solving differential equations to process inputs. This approach enables variable timestep processing and potentially more natural handling of temporal relationships. Similarly, Neural Controlled Differential Equations (Neural CDEs) extend this framework to handle irregular time series data while maintaining end-to-end differentiability.

Graph Neural Networks (GNNs) provide yet another alternative by modeling sequences as structured graphs. This approach enables explicit modeling of hierarchical relationships and long-range dependencies through message passing between nodes. Graph-based architectures can capture complex dependencies that may be difficult to model with purely sequential approaches, though these architectures may require careful design of graph structure and update rules.

### 13. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. Custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 14. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

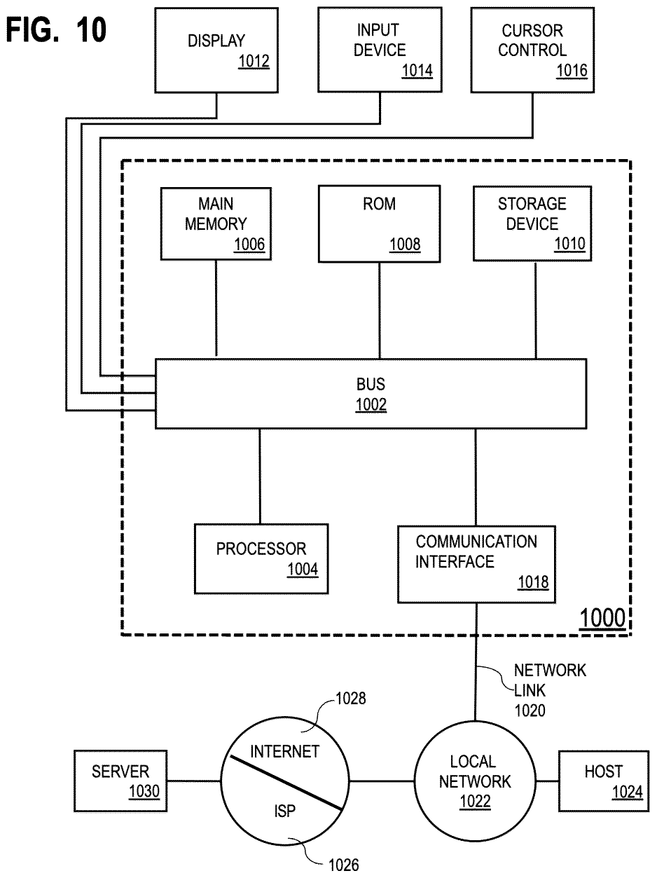

For example, FIG. 10 is a block diagram that illustrates a computer system 1000 upon which an embodiment of the disclosure may be implemented. Computer system 1000 includes a bus 1002 or other communication mechanism for communicating information, and a hardware processor 1004 coupled with bus 1002 for processing information. Hardware processor 1004 may be, for example, a general-purpose microprocessor.

Computer system 1000 also includes a main memory 1006, such as a random-access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or a Solid-State Drive (SSD) is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 based on processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the worldwide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

### 15. Miscellaneous; Extensions

Unless otherwise defined, all terms (including technical and scientific terms) are to be given their ordinary and customary meaning to a person of ordinary skill in the art and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

1. One or more non-transitory computer-readable media comprising instructions which, when executed by one or more hardware processors, cause performance of operations comprising:
obtaining sensitive entity de-identification data comprising a set of entities identified in a first text by a sensitive entity de-identification system as sensitive entities;
sending a prompt to a large language model (LLM), the prompt comprising the set of entities identified by the sensitive entity de-identification system as sensitive entities and comprising at least a portion of the first text;
obtaining an output of the LLM based on sending the prompt to the LLM, the output identifying an entity that is not included in the set of entities identified by the sensitive entity de-identification system as sensitive entities, wherein the output indicates that the entity is a sensitive entity;
based on the output indicating that the entity is a sensitive entity, generating a second text that comprises at least a portion of the first text, that does not include the entity, and that does not include the set of entities identified by the sensitive entity de-identification system as sensitive entities; and
storing the second text in a non-transitory computer-readable medium.

2. The one or more non-transitory computer-readable media of claim 1, wherein the prompt instructs the LLM to determine if all entities of a predetermined sensitive entity type in at least a portion of the first text are included in the set of entities.

3. The one or more non-transitory computer-readable media of claim 1, the operations further comprising:
based on obtaining the output, verifying that the first text comprises the entity identified by the output; and
based on verifying that the first text comprises the entity identified by the output, generating the second text to not include the entity.

4. The one or more non-transitory computer-readable media of claim 1, wherein:
the prompt is a first prompt;
the output is a first output;
the entity is a first entity;
the LLM is a first LLM;
the operations further comprise:
sending a second prompt to a second large language model (LLM) that is the first LLM or a different LLM, the second prompt comprising a second entity of the set of entities and at least a portion of the first text;
obtaining a second output of the second LLM based on sending the second prompt to the second LLM, the second output indicating that the second entity is not a sensitive entity; and
based on the second output indicating that the second entity is not a sensitive entity, generating the second text to include the second entity.

5. The one or more non-transitory computer-readable media of claim 1, wherein:
the prompt is a first prompt;
the output is a first output;
the entity is a first entity;
the LLM is a first LLM;
the sensitive entity de-identification data is first sensitive entity de-identification data;
the first sensitive entity de-identification data indicates that a second entity of the set of entities is a first predetermined sensitive entity type;
the operations further comprise:
sending a second prompt to a second large language model (LLM) that is the first LLM or a different LLM, the second prompt comprising the second entity of the set of entities and at least a portion of the first text;
obtaining a second output of the second LLM based on sending the second prompt to the second LLM, the second output indicating that the second entity is a second predetermined sensitive entity type that is not the first predetermined sensitive entity type;
based on the second output indicating that the second entity is the second predetermined sensitive entity type that is not the first predetermined sensitive entity type, storing second sensitive entity de-identification data that indicates that second entity is the second predetermined sensitive entity type; and
generating the second text based at least in part on the second sensitive entity de-identification data.

6. The one or more non-transitory computer-readable media of claim 1, the operations further comprising:
determining a sensitive entity de-identification precision value based on a number of entities in the first text incorrectly identified as a sensitive entity and a number of sensitive entities in the first text misclassified as to sensitive entity type, wherein the number of entities in the first text incorrectly identified as a sensitive entity is determined based on sending a prompt to a large language model (LLM), and wherein the number of sensitive entities in the first text misclassified as to sensitive entity type is determined based on sending a prompt to a LLM; and
generating an alert based on the sensitive entity de-identification precision value.

7. The one or more non-transitory computer-readable media of claim 1, the operations further comprising:
based on the output, determining an all-or-nothing recall value for a sensitive entity type of a set of sensitive entity types; and
generating an alert based on determining that the all-or-nothing recall value for the sensitive entity type indicates that not all instances of the sensitive entity type in the first text have been identified as sensitive entities.

8. A method comprising:
obtaining sensitive entity de-identification data comprising a set of entities identified in a first text by a sensitive entity de-identification system as sensitive entities;
sending a prompt to a large language model (LLM), the prompt comprising the set of entities identified by the sensitive entity de-identification system as sensitive entities and comprising at least a portion of the first text;
obtaining an output of the LLM based on sending the prompt to the LLM, the output identifying an entity that is not included in the set of entities identified by the sensitive entity de-identification system as sensitive entities, wherein the output indicates that the entity is a sensitive entity;
based on the output indicating that the entity is a sensitive entity, generating a second text that comprises at least a portion of the first text, that does not include the entity, and that does not include the set of entities identified by the sensitive entity de-identification system as sensitive entities; and
storing the second text in a non-transitory computer-readable medium.

9. The method of claim 8, wherein the prompt instructs the LLM to determine if all entities of a predetermined sensitive entity type in at least a portion of the first text are included in the set of entities.

10. The method of claim 8, further comprising:
based on obtaining the output, verifying that the first text comprises the entity identified by the output; and
based on verifying that the first text comprises the entity identified by the output, generating the second text to not include the entity.

11. The method of claim 8, wherein:
the prompt is a first prompt;
the output is a first output;
the entity is a first entity;
the LLM is a first LLM;
the method further comprises:
sending a second prompt to a second large language model (LLM) that is the first LLM or a different LLM, the second prompt comprising a second entity of the set of entities and at least a portion of the first text;
obtaining a second output of the second LLM based on sending the second prompt to the second LLM, the second output indicating that the second entity is not a sensitive entity; and
based on the second output indicating that the second entity is not a sensitive entity, generating the second text to include the second entity.

12. The method of claim 8, wherein:
the prompt is a first prompt;
the output is a first output;
the entity is a first entity;
the LLM is a first LLM;
the sensitive entity de-identification data is first sensitive entity de-identification data;
the first sensitive entity de-identification data indicates that a second entity of the set of entities is a first predetermined sensitive entity type;
the method further comprises:
sending a second prompt to a second large language model (LLM) that is the first LLM or a different LLM, the second prompt comprising the second entity of the set of entities and at least a portion of the first text;
obtaining a second output of the second LLM based on sending the second prompt to the second LLM, the second output indicating that the second entity is a second predetermined sensitive entity type that is not the first predetermined sensitive entity type;
based on the second output indicating that the second entity is the second predetermined sensitive entity type that is not the first predetermined sensitive entity type, storing second sensitive entity de-identification data that indicates that second entity is the second predetermined sensitive entity type; and
generating the second text based at least in part on the second sensitive entity de-identification data.

13. The method of claim 8, further comprising:
determining a sensitive entity de-identification precision value based on a number of entities in the first text incorrectly identified as a sensitive entity and a number of sensitive entities in the first text misclassified as to sensitive entity type, wherein the number of entities in the first text incorrectly identified as a sensitive entity is determined based on sending a prompt to a large language model (LLM), and wherein the number of sensitive entities in the first text misclassified as to sensitive entity type is determined based on sending a prompt to a LLM; and
generating an alert based on the sensitive entity de-identification precision value.

14. The method of claim 8, further comprising:
based on the output, determining an all-or-nothing recall value for a sensitive entity type of a set of sensitive entity types; and
generating an alert based on determining that the all-or-nothing recall value for the sensitive entity type indicates that not all instances of the sensitive entity type in the first text have been identified as sensitive entities.

15. A system comprising:
at least one device comprising a hardware processor; and
instructions which, when executed, cause the system to perform operations comprising:
obtaining sensitive entity de-identification data comprising a set of entities identified in a first text by a sensitive entity de-identification system as sensitive entities;
sending a prompt to a large language model (LLM), the prompt comprising the set of entities identified by the sensitive entity de-identification system as sensitive entities and comprising at least a portion of the first text;
obtaining an output of the LLM based on sending the prompt to the LLM, the output identifying an entity that is not included in the set of entities identified by the sensitive entity de-identification system as sensitive entities, wherein the output indicates that the entity is a sensitive entity;
based on the output indicating that the entity is a sensitive entity, generating a second text that comprises at least a portion of the first text, that does not include the entity, and that does not include the set of entities identified by the sensitive entity de-identification system as sensitive entities; and
storing the second text in a non-transitory computer-readable medium.

16. The system of claim 15, wherein the prompt instructs the LLM to determine if all entities of a predetermined sensitive entity type in at least a portion of the first text are included in the set of entities.

17. The system of claim 15, the operations further comprising:
based on obtaining the output, verifying that the first text comprises the entity identified by the output; and
based on verifying that the first text comprises the entity identified by the output, generating the second text to not include the entity.

18. The system of claim 15, wherein:
the prompt is a first prompt;
the output is a first output;
the entity is a first entity;
the LLM is a first LLM;
the operations further comprise:
sending a second prompt to a second large language model (LLM) that is the first LLM or a different LLM, the second prompt comprising a second entity of the set of entities and at least a portion of the first text;
obtaining a second output of the second LLM based on sending the second prompt to the second LLM, the second output indicating that the second entity is not a sensitive entity; and
based on the second output indicating that the second entity is not a sensitive entity, generating the second text to include the second entity.

19. The system of claim 15, wherein:
the prompt is a first prompt;
the output is a first output;
the entity is a first entity;
the LLM is a first LLM;
the sensitive entity de-identification data is first sensitive entity de-identification data;
the first sensitive entity de-identification data indicates that a second entity of the set of entities is a first predetermined sensitive entity type;
the operations further comprise:
sending a second prompt to a second large language model (LLM) that is the first LLM or a different LLM, the second prompt comprising the second entity of the set of entities and at least a portion of the first text;
obtaining a second output of the second LLM based on sending the second prompt to the second LLM, the second output indicating that the second entity is a second predetermined sensitive entity type that is not the first predetermined sensitive entity type;
based on the second output indicating that the second entity is the second predetermined sensitive entity type that is not the first predetermined sensitive entity type, storing second sensitive entity de-identification data that indicates that second entity is the second predetermined sensitive entity type; and
generating the second text based at least in part on the second sensitive entity de-identification data.

20. The system of claim 15, the operations further comprising:
determining a sensitive entity de-identification precision value based on a number of entities in the first text incorrectly identified as a sensitive entity and a number of sensitive entities in the first text misclassified as to sensitive entity type, wherein the number of entities in the first text incorrectly identified as a sensitive entity is determined based on sending a prompt to a large language model (LLM), and wherein the number of sensitive entities in the first text misclassified as to sensitive entity type is determined based on sending a prompt to a LLM; and
generating an alert based on the sensitive entity de-identification precision value.
